(19) United States
(12) Patent Application Publication
(10) Pub. No.: US 2021/0191696 A1
(43) Pub. Date: Jun. 24, 2021

(54) METHODS, APPARATUS, AND ARTICLES OF MANUFACTURE TO IDENTIFY AND INTERPRET CODE

(71) Applicant: Intel Corporation, Santa Clara, CA (US)

(72) Inventors: Alejandro Ibarra Von Borstel, Manchaca, TX (US); Hector Cordourier Maruri, Guadalajara (MX); Julio Cesar Zamora Esquivel, Zapopan (MX); Jorge Emmanuel Ortiz Garcia, Manchaca, TX (US); Guillermo Antonio Palomino Sosa, Pflugerville, TX (US); Fernando Ambriz Meza, Manchaca, TX (US); David Israel Gonzalez Aguirre, Hillsboro, OR (US)

(21) Appl. No.: 17/121,686

(22) Filed: Dec. 14, 2020

(51) Int. Cl. G06F 8/36; G06F 9/54; G06F 16/33; G06F 8/41

(52) U.S. Cl. CPC G06F 8/36; G06F 8/41; G06F 16/3344; G06F 9/54

(57) ABSTRACT

Methods, apparatus, systems, and articles of manufacture are disclosed to identify and interpret code. An example apparatus includes a natural language (NL) processor to process NL features to identify a keyword, an entity, and an intent of an NL string included in an input retrieved from a user; a database driver to transmit a query to a database including an ontological representation of a version control system, wherein the query is a parameterized semantic query including the keyword, the entity, and the intent of the NL string; and an application programming interface (API) to present to the user a code snippet determined based on the query, the code snippet being at least one of uncommented or non-self-documented.

### FIELD OF THE DISCLOSURE

This disclosure relates generally to code reuse, and, more particularly, to methods, apparatus, and articles of manufacture to identify and interpret code.

### BACKGROUND

Programmers have long reused sections of code from one program in another program. A general principle behind code reuse is that parts of a computer program written at one time can be used in the construction of other programs written at a later time. Examples of code reuse include software libraries, reusing a previous version of a program as a starting point for a new program, copying some code of an existing program into a new program, among others.

### BRIEF DESCRIPTION OF THE DRAWINGS

FIG. 1 is a network diagram including an example semantic search engine.

FIG. 2 is a block diagram showing additional detail of the example semantic search engine of FIG. 1.

FIG. 3 is a schematic illustration of an example topology of a Bayesian neural network (BNN) that may implement the natural language processing (NLP) model and/or the code classification (CC) model executed by the semantic search engine of FIGS. 1 and/or 2.

FIG. 4 is a graphical illustration of example training data to train the NLP model executed by the semantic search engine of FIGS. 1 and/or 2.

FIG. 5 is a block diagram illustrating an example process executed by the semantic search engine of FIGS. 1 and/or 2 to generate example ontology metadata from the version control system (VCS) of FIG. 1.

FIG. 6 is a graphical illustration of example ontology metadata generated by the application programming interface (API) of FIGS. 2 and/or 5 for a commit including comment and/or message parameters.

FIG. 7 is a graphical illustration of example ontology metadata stored in the database of FIGS. 1 and/or 5 after the NL processor of FIGS. 2 and/or 5 has identified the intent associated with one or more comment and/or message parameters of a commit in the VCS of FIGS. 1 and/or 5.

FIG. 8 is a graphical illustration of example features to be processed by the example CC model executor of FIGS. 2 and/or 5 to train the CC model.

FIG. 9 is a block diagram illustrating an example process executed by the semantic search engine of FIGS. 1 and/or 2 to process queries from the user device of FIG. 1.

FIG. 10 is a flowchart representative of machine readable instructions which may be executed to implement the semantic search engine of FIGS. 1, 2, and/or 5 to train the NLP model of FIGS. 2, 3, and/or 5, generate ontology metadata, and train the CC model of FIGS. 2, 3, and/or 5.

FIG. 11 is a flowchart representative of machine readable instructions which may be executed to implements the semantic search engine of FIGS. 1, 2, and/or 9 to process queries with the NLP model of FIGS. 2, 3, and/or 9 and/or the CC model of FIGS. 2, 3, and/or 9.

FIG. 12 is a block diagram of an example processing platform structured to execute the instructions of FIGS. 10 and/or 11 to implement the semantic search engine of FIGS. 1, 2, 5, and/or 9.

FIG. 13 is a block diagram of an example software distribution platform to distribute software (e.g., software corresponding to the example computer readable instructions of FIG. 12) to client devices such as those owned and/or operated by consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers).

The figures are not to scale. In general, the same reference numbers will be used throughout the drawing(s) and accompanying written description to refer to the same or like parts. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

Reducing time to market for new software and/or hardware products is a very challenging task. For example, companies often try to balance many variables including reducing development time, increasing development quality, and reducing development cost (e.g., monetary expenditures incurred in development). Generally, at least one of these variables will be negatively impacted to reduce time to market of new products. However, efficiently and/or effectively reusing source code between developers and/or development teams that contribute to the same and/or similar projects can benefit (e.g., highly) the research and development (R&D) time to market for products.

Code reuse is inherently challenging for new and/or inexperienced developers. For example, such developers can struggle to accurately and quickly identify source code that is suitable for their application. Developers often include comments in their code (e.g., source code) to enable reuse and specify the intent of certain lines of code (LOCs). Code that includes many comments compared to the number of LOCs is referred to herein as commented code. Additionally or alternatively, in lieu of comments, developers sometimes include labels (e.g., names) for functions and/or variables that relate to the use and/or meaning of the functions and/or variables to enable reuse of the code. Code that includes (a) many functions and/or variables with labels that relate to the use and/or meaning of the functions and/or variables compared to (b) the number of functions and/or variables of the code is referred to herein as self-documented code.

To improve reuse of code, some techniques use machine learning based natural language processing (NLP) to analyze comments and code. Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.). Alternatively, unsupervised training (e.g., used in deep learning, a subset of machine learning, etc.) involves inferring patterns from inputs to select parameters for the ML/AI model (e.g., without the benefit of expected (e.g., labeled) outputs).

One technique to improve code reuse finds the semantic similarities between comments and LOC(s). This technique correlates comments with keywords or entities in the code. In this technique, a keyword refers to a word in code that has a specific meaning in a particular context. For example, such keywords often coincide with reserved words which are words that cannot be used as an identifier (e.g., a name of a variable, function, or label) in a given programming language. However, such keywords need not have a one-to-one correspondence with reserved words. For example, in some languages, all keywords (as used in this technique) are reserved words but not all reserved words are keywords. In C++, reserved words include if, then, else, among others. Examples of keywords that are not reserved words in C++ include main. In this technique, an entity refers to a unit within a given programming language. In C++, entities include values, objects, references, structured bindings, functions, enumerators, types, class members, templates, templates specializations, namespaces, parameter packs, among others. Generally, entities include identifiers, separators, operators, literals, among others.

Another technique to improve code reuse determines the intent of a method based on keywords and entities in the code and comments. This technique extracts method names, method invocations, enums, string literals, and comments from the code. This technique uses text embedding to generate vector representations of the extracted features. Two vectors are close together in vector space if the words they represent often occur in similar contexts. This technique determines the intent of code as a weighted average of the embedding vectors. This technique returns code for a given natural language (NL) query by generating embedding vectors for the NL query, determining the intent of the NL query (e.g., via the weighted average), and performing a similarity search against weighted averages of methods. As used herein, when referencing NL text, keywords refer to actions describing a software development process (e.g., define, restored, violated, comments, formula, etc.). As used herein, when referencing NL text, entities refer to n-gram groupings of words describing source code function (e.g., macros, headers, etc.).

The challenge of reusing code is exacerbated when developers do not comment or self-document their code, making it difficult or impracticable (e.g., practically impossible) for developers to find the appropriate resources (e.g., code to reuse) and/or avoid resynthesizing product features or compounded capabilities of a product. Code that (1) does not include comments, (2) includes very few comments compared to the number of LOCs, or (3) includes comments in a convention that is unique to the developer of the code and not clearly understood by others is referred to herein as uncommented code. Code that (1) does not include functions and/or variables with labels that relate to the use and/or meaning of the functions and/or variables or (2) includes (a) very few functions and/or variables with labels that relate to the use and/or meaning of the functions and/or variables compared to (b) the number of functions and/or variables of the code is referred to herein as non-self-documented code.

Previous techniques to improve the reuse of code rely on finding relations between comments, entities, and tokens in the source code to detect the intent of a code snippet. As used herein, a token refers to a string with an identified meaning. Tokens include a token name and/or a token value. For example, a token for a keyword in NL text may include a token name of “keyword” and a token value of “not equivalent.” Additionally or alternatively, a token for a keyword in code (as used in previous techniques) may include a token name of “keyword” and a token value of “while.” Previous techniques subsequently perform an action based on the detected intent. However, as described above, in real-world scenarios, most code is uncommented or non-self-documented. As such, previous techniques are very inefficient and/or ineffective in real-world scenarios. These bad practices (e.g., failing to comment code or failing to self-document code) of developers lead to poor intent detection performance for the source code when using previous techniques. Accordingly, previous techniques fail to find source code examples in datasets such as those generated from a version control system (VCS). Thus, previous techniques negatively (e.g., highly negatively) impact development and delivery times of software and/or hardware products.

Examples disclosed herein include a code search engine that performs semantic searches to find and/or recommend code snippets even when the developer of the code snippet did not follow good documentation practices (e.g., commenting and/or self-documenting). To match NL queries with code, examples disclosed herein merge an ontological representation of VCS content with probabilistic distribution (PD) modeling (e.g., via one or more Bayesian neural networks (BNNs)) of comments and code intent (e.g., of code-snippet development intent). Examples disclosed herein train one or more BNNs with the entities and/or relations of an ontological representation of well documented (e.g., commented and/or self-documented) code. As such, examples disclosed herein probabilistically associate intents with non-commented code snippets. Accordingly, examples disclosed herein provide uncertainty and context-aware smart code completion.

Examples disclosed herein merge natural language processing and/or natural language understanding, probabilistic computing, and knowledge representation techniques to model the content (e.g., source code and/or associated parameters) of VCSs. As such, examples disclosed herein represent the content of VCSs as a meaningful, ontological representation enabling semantic search of code snippets that would be otherwise impossible, due to the lack of readable semantic constructs (e.g., comments and/or self-documented) in raw source code. Examples disclosed herein process natural language queries, match the intent of the natural language queries with uncommented and/or non-self-documented code snippets, and recommend how to use the uncommented and/or non-self-documented code snippets. Examples disclosed herein process raw uncommented and/or non-self-documented code snippets, identify the intents of the code snippets, and return a set of VCS commit reviews that relate to the intents of the code snippets.

Accordingly, examples disclosed herein accelerate the time to market of new products (e.g., software and/or hardware) by enabling developers to better reuse their resources (e.g., code that may be reused). For example, examples disclosed herein prevent developers from having to code solutions from scratch, for example, when they are not found in other repositories (e.g., Stack Overflow). As such, examples disclosed herein reduce the time to market for companies that are developing new products.

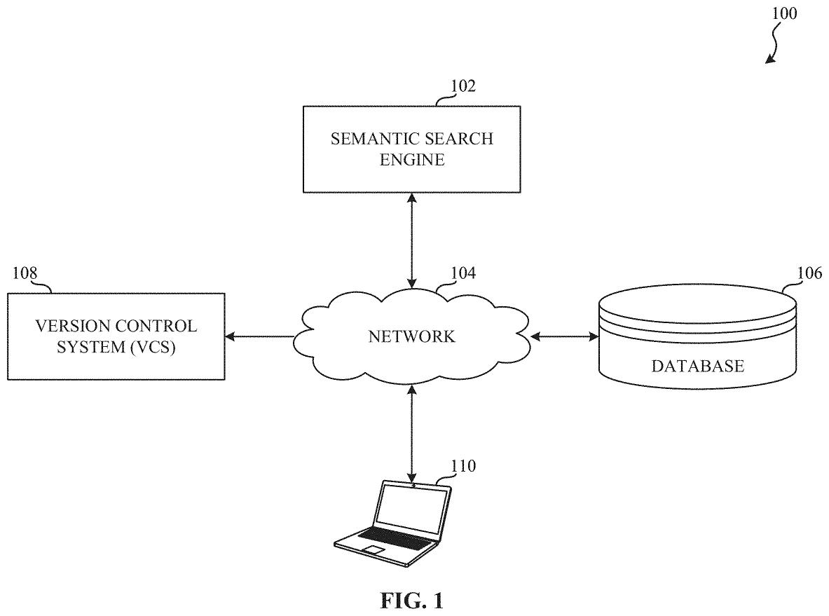

FIG. 1 is a network diagram 100 including an example semantic search engine 102. The network diagram 100 includes the example semantic search engine 102, an example network 104, an example database 106, an example VCS 108, and an example user device 110. In the example of FIG. 1, the example semantic search engine 102, the example database 106, the example VCS 108, the example user device 110, and/or one or more additional devices are communicatively coupled via the example network 104.

In the illustrated example of FIG. 1, the semantic search engine 102 is implemented by one or more processors executing instructions. For example, the semantic search engine 102 may be implemented by one or more processors executing one or more trained machine learning models and/or executing instructions to implement peripheral components to the one or more ML models such as preprocessors, features extractors, model trainers, database drivers, application programming interfaces (APIs), among others. In additional or alternative examples, the semantic search engine 102 can be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)).

In the illustrated example of FIG. 1, the semantic search engine 102 is implemented by one or more controllers that train other components of the semantic search engine 102 such as one or more BNNs to generate a searchable ontological representation (discussed further herein) of the VCS 108, determine the intent of NL queries, and/or to interpret queries including code snippets (e.g., commented, uncommented, self-documented, and/or non-self-documented). In additional or alternative examples, the semantic search engine 102 can implement any other ML/AI model. In the example of FIG. 1, the semantic search engine 102 offers one or more services and/or products to end-users. For example, the semantic search engine 102 provides one or more trained models for download, host a web-interface, among others. In some examples, the semantic search engine 102 provides end-users with a plugin that implements the semantic search engine 102. In this manner, the end-user can implement the semantic search engine 102 locally (e.g., at the user device 110).

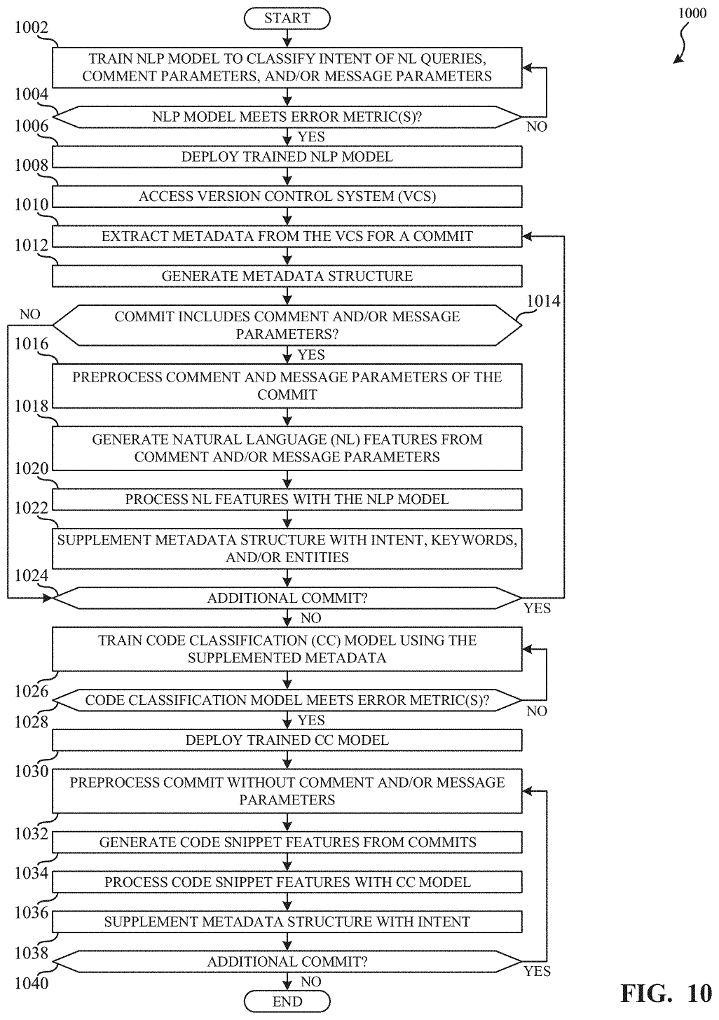

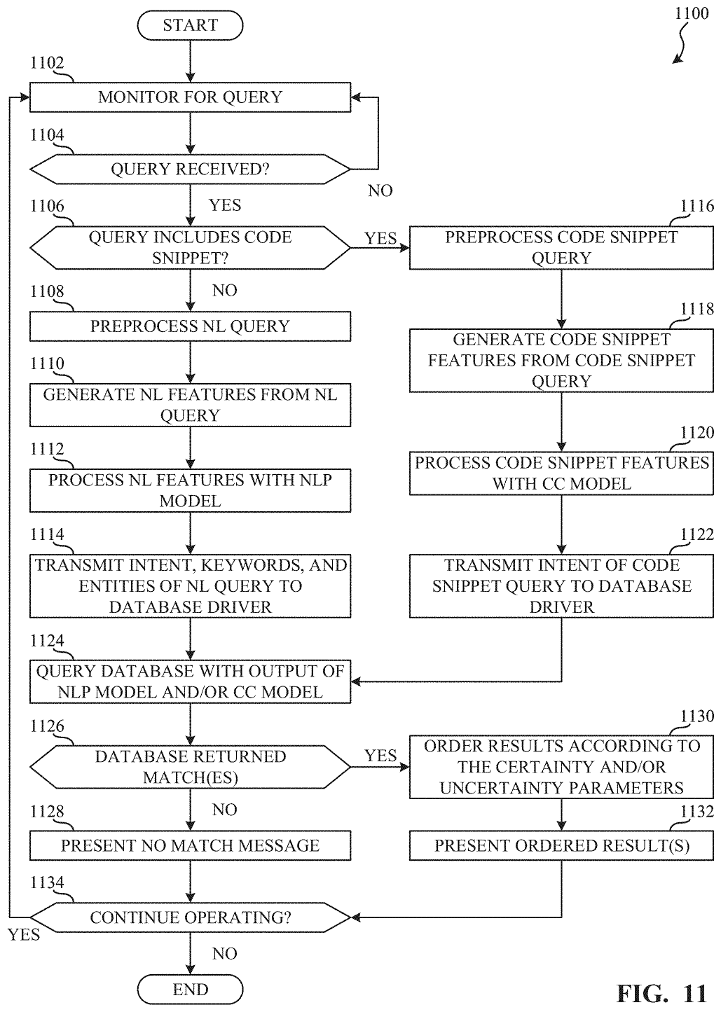

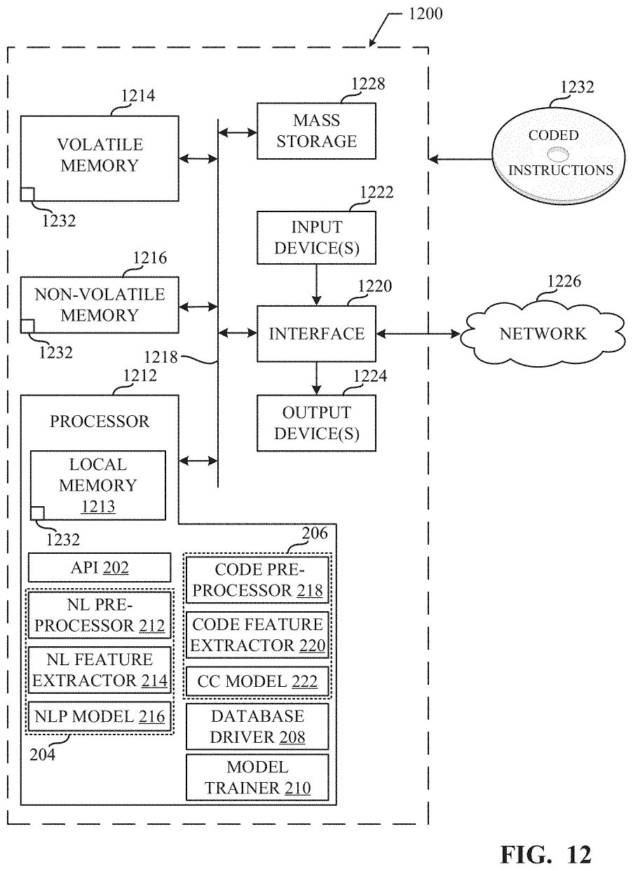

In some examples, the example semantic search engine 102 implements example means for identifying and interpreting code. The means for identifying and interpreting code is implemented by executable instructions such as that implemented by at least blocks 1002, 1004, 1006, 1008, 1010, 1012, 1014, 1016, 1018, 1020, 1022, 1024, 1026, 1028, 1030, 1032, 1034, 1036, 1038, and 1040 of FIG. 10 and/or at least blocks 1102, 1104, 1106, 1108, 1110, 1112, 1114, 1116, 1118, 1120, 1122, 1124, 1126, 1128, 1130, 1132, and 1134 of FIG. 11. The executable instructions of blocks 1002, 1004, 1006, 1008, 1010, 1012, 1014, 1016, 1018, 1020, 1022, 1024, 1026, 1028, 1030, 1032, 1034, 1036, 1038, and 1040 of FIG. 10 and/or blocks 1102, 1104, 1106, 1108, 1110, 1112, 1114, 1116, 1118, 1120, 1122, 1124, 1126, 1128, 1130, 1132, and 1134 of FIG. 11 may be executed on at least one processor such as the example processor 1212 of FIG. 12. In other examples, the means for identifying and interpreting code is implemented by hardware logic, hardware implemented state machines, logic circuitry, and/or any other combination of hardware, software, and/or firmware.

In the illustrated example of FIG. 1, the network 104 is the Internet. However, the example network 104 may be implemented using any suitable wired and/or wireless network(s) including, for example, one or more data buses, one or more Local Area Networks (LANs), one or more wireless LANs, one or more cellular networks, one or more private networks, one or more public networks, among others. In additional or alternative examples, the network 104 is an enterprise network (e.g., within businesses, corporations, etc.), a home network, among others. The example network 104 enables the semantic search engine 102, the database 106, the VCS 108, and the user device 110 to communicate. As used herein, the phrase “in communication,” including variances thereof (e.g., communicate, communicatively coupled, etc.), encompasses direct communication and/or indirect communication through one or more intermediary components and does not require direct physical (e.g., wired) communication and/or constant communication, but rather includes selective communication at periodic or aperiodic intervals, as well as one-time events.

In the illustrated example of FIG. 1, the database 106 is implemented by a graph database (GDB). For example, as a GDB, the database 106 relates data stored in the database 106 to various nodes and edges where the edges represent relationships between the nodes. The relationships allow data stored in the database 106 to be linked together such that, related data may be retrieved in a single query. In the example of FIG. 1, the database 106 is implemented by one or more Neo4J graph databases. In additional or alternative examples, the database 106 may be implemented by one or more ArangoDB graph databases, one or more OrientDB graph databases, one or more Amazon Neptune graph databases, among others. For example, suitable implementations of the database 106 will be capable of storing probability distributions of source code intents either implicitly or explicitly by means of text (e.g., string) similarity metrics.

In the illustrated example of FIG. 1, the VCS 108 is implemented by one or more computers and/or one or more memories associated with a VCS platform. In some examples, the components that the VCS 108 includes may be distributed (e.g., geographically diverse). In the example of FIG. 1, the VCS 108 manages changes to computer programs, websites, and/or other information collections. A user of the VCS 108 (e.g., a developer accessing the VCS 108 via the user device 110) may edit a program and/or other code managed by the VCS 108. To edit the code, the developer operates on a working copy of the latest version of the code managed by the VCS 108. When the developer reaches a point at which they would like to merge their edits with the latest version of the code at the VCS 108, the developer commits their changes with the VCS 108. The VCS 108 then updates the latest version of the code to reflect the working copy of the code across all instances of the VCS 108. In some examples, the VCS 108 may rollback a commit (e.g., when a developer would like to review a previous version of a program). Users of the VCS 108 (e.g., reviewers, other users who did not draft the code, etc.) may apply comments to code in a commit and/or send messages to the drafter of the code to review and/or otherwise improve the code in a commit.

In the illustrated example of FIG. 1, the VCS 108 is implemented by one or more computers and/or one or more memories associated with the Gerrit Code Review platform. In additional or alternative examples, the one or more computers and/or one or more memories that implement the VCS 108 may be associated with another VCS platform such as AWS CodeCommit, Microsoft Team Foundation Server, Git, Subversion, among others. In the example of FIG. 1, commits with the VCS 108 are associated with parameters such as change, subject, message, revision, file, code line, comment, and diff parameters. The change parameter corresponds to an identifier of the commit at the VCS 108. The subject parameter corresponds to the change requested by the developer in the commit. The message parameter corresponds to messages posted by reviewers of the commit. The revision parameter corresponds to the revision number of the subject as there can be multiple revisions to the same subject. The file parameter corresponds to the file being modified by the commit. The code line parameter corresponds to the LOC on which reviewers commented. The comment parameter corresponds to the comment left by reviewers. The diff parameter specifies whether the commit added to or removed from the previous version of the source implementation.

In the illustrated example of FIG. 1, the user device 110 is implemented by a laptop computer. In additional or alternative examples, the user device 110 can be implemented by a mobile phone, a tablet computer, a desktop computer, a server, among others, including one or more analog or digital circuit(s), logic circuits, programmable processor(s), programmable controller(s), GPU(s), DSP(s), ASIC(s), PLD(s) and/or FPLD(s). The user device 110 can additionally or alternatively be implemented by a CPU, GPU, an accelerator, a heterogeneous system, among others.

In the illustrated example of FIG. 1, the user device 110 subscribes to and/or otherwise purchases a product and/or service from the semantic search engine 102 to access one or more machine learning models trained to ontologically model a VCS, identify the intent of NL queries, return code snippets retrieved from a database based on the intent of the NL queries, process queries including uncommented and/or non-self-documented code snippets, and return intents of the code snippets and/or related VCS commits. For example, the user device 110 accesses the one or more trained models by downloading the one or more models from the semantic search engine 102, accessing a web-interface hosted by the semantic search engine 102 and/or another device, among other techniques. In some examples, the user device 110 installs a plugin to implement a machine learning application. In such an example, the plugin implements the semantic search engine 102.

In example operation, the semantic search engine 102 accesses and extracts information from the VCS 108 for a given commit. For example, the semantic search engine 102 extracts the change, subject, message, revision, file, code line, comment, and diff parameters from the VCS 108 for a commit. The semantic search engine 102 generates a metadata structure including the extracted information from the VCS 108. For example, the metadata structure corresponds to an ontological representation of the content of the commit. In examples disclosed herein, an ontological representation of a commit includes a graphical representation (e.g., nodes, edges, etc.) of the data associated with the commit and illustrates the categories, properties, and relationships between the data associated with the commit. For example, the data associated with the commit includes the change, subject, message, revision, file, code line, comment, and diff parameters.

In example operation, for commits including comment and/or message parameters, the semantic search engine 102 preprocesses the comment and/or message parameters with a trained natural language processing (NLP) machine learning model. After the semantic search engine 102 preprocesses the comment and/or message parameters, the semantic search engine 102 extracts NL features from the comment and/or message parameters. The semantic search engine 102 processes the NL features. For example, the semantic search engine 102 identifies one or more entities, one or more keywords, and/or one or more intents of the comment and/or message parameters based on the NL features and updates the metadata structure with (e.g., stores in the metadata structure) the identified entities, keywords, and/or intents. Additionally or alternatively, the semantic search engine 102 generates another metadata structure for the commit including a simplified ontological representation of the commit, including the identified intent(s). The semantic search engine 102 also extracts metadata for additional commits.

In examples disclosed herein, each identified intent corresponds to a probabilistic distribution (PD) specifying at least one of a certainty parameter or an uncertainty parameter. The certainty and uncertainty parameters correspond to a level of confidence of the semantic search engine 102 in the identified intent. For example, the certainty parameter corresponds to the mean value of confidence with which a ML/AI model executed by the semantic search engine 102 identified the intent and the uncertainty parameter corresponds to the standard deviation of the identified intent. Accordingly, examples disclosed herein generate weighted relations between VCS ontology entities based on the development intent probability distributions related to the entities. In example operation, based on the one or more metadata structures generated from the commits of the VCS 108, including the identified intents and certainty and uncertainty parameters, the semantic search engine 102 generates a training data set for a code classification (CC) machine learning model of the semantic search engine 102. Subsequently, the semantic search engine 102 trains the CC model of the semantic search engine 102 with the training dataset.

In example operation, after the CC machine learning model is trained, the semantic search engine 102 deploys the CC model to process code for commits in the VCS 108 that do not include comment and/or message parameters. For example, the semantic search engine 102 preprocess commits without comment and/or message parameters, generates code snippet features for these commits, and processes the code snippet features with the CC model to identify the intent of the code from commits without comment and/or message parameters. In this manner, the semantic search engine 102 is processing code snippet features to identify the intent of the code from commits without comment and/or message parameters. The semantic search engine 102 then supplements the metadata structures in the database 106 with the identified intent of the code.

In example operation, the semantic search engine 102 also processes NL queries and/or code snippet queries. For example, the semantic search engine 102 deploys the NLP model and/or the CC model locally at the semantic search engine 102 to process NL queries and/or code snippet queries, respectively. Additionally or alternatively, the semantic search engine 102 deploys the NLP model, the CC model, and/or other components to the user device 110 to implement the semantic search engine 102.

In example operation, after deployment of the NLP model and the CC model, the semantic search engine 102 monitors a user interface for a query. For example, the semantic search engine 102 monitors an interface of a web application hosted by the semantic search engine 102 for queries from users (e.g., developers). Additionally or alternatively, if the semantic search engine 102 is implemented locally at a user device (e.g., the user device 110), the semantic search engine 102 monitors an interface of an application executing locally on the user device for queries from users. When the semantic search engine 102 receives a query, the semantic search engine 102 determines whether the query includes a code snippet or an NL input. In examples disclosed herein, code snippet queries include commented, uncommented, self-documented, and/or non-self-documented code snippets.

In example operation, when the query is an NL query, the semantic search engine 102 preprocesses the NL query, extracts NL features from the NL query, and processes the NL features to determine the intent, entities, and keywords of the NL query. Subsequently, the semantic search engine 102 queries the database 106 with the intent of the NL query. When the query is a code snippet query, the semantic search engine 102 preprocesses the code snippet query, extracts features from the code snippet, processes the code snippet features, and queries the database 106 with the intent of the code snippet. If the database 106 returns one or more matches to the query, the semantic search engine 102 orders and presents the matches according to at least one of a certainty parameter or an uncertainty parameter determined by the semantic search engine 102 for each matching result. If the database 106 does not return matches to the query, the semantic search engine 102 presents a “no match” message (discussed further herein).

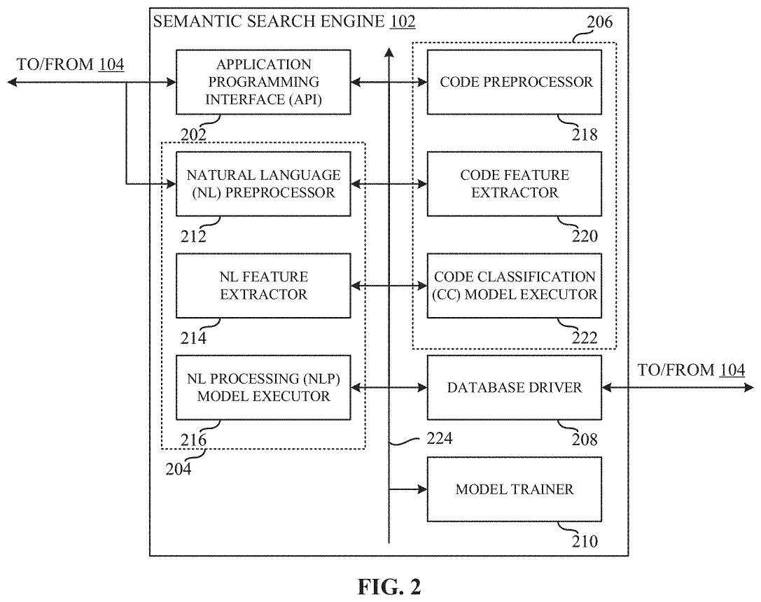

FIG. 2 is a block diagram showing additional detail of the example semantic search engine 102 of FIG. 1. In the example of FIG. 2, the semantic search engine 102 includes an example API 202, an example NL processor 204, an example code classifier 206, an example database driver 208, and an example model trainer 210. The example NL processor 204 includes an example NL preprocessor 212, an example NL feature extractor 214, and an example NLP model executor 216. The example code classifier 206 includes an example code preprocessor 218, an example code feature extractor 220, and an example CC model executor 222.

In the illustrated example of FIG. 2, any of the API 202, the NL processor 204, the code classifier 206, the database driver 208, the model trainer 210, the NL preprocessor 212, the NL feature extractor 214, the NLP model executor 216, the code preprocessor 218, the code feature extractor 220, and/or the CC model executor 222 communicate via an example communication bus 224. In examples disclosed herein, the communication bus 224 may be implemented using any suitable wired and/or wireless communication. In additional or alternative examples, the communication bus 224 includes software, machine readable instructions, and/or communication protocols by which information is communicated among the API 202, the NL processor 204, the code classifier 206, the database driver 208, the model trainer 210, the NL preprocessor 212, the NL feature extractor 214, the NLP model executor 216, the code preprocessor 218, the code feature extractor 220, and/or the CC model executor 222.

In the illustrated example of FIG. 2, the API 202 is implemented by one or more processors executing instructions. Additionally or alternatively, the API 202 can be implemented by one or more analog or digital circuit(s), logic circuits, programmable processor(s), programmable controller(s), GPU(s), DSP(s), ASIC(s), PLD(s) and/or FPLD(s). In the example of FIG. 2, the API 202 accesses the VCS 108 via the network 104. The API 202 also extracts metadata from the VCS 108 for a given commit. For example, the API 202 extracts metadata including the change, subject, message, revision, file, code line, comment, and/or diff parameters. The API 202 generates a metadata structure to store the extracted metadata in the database 106. The API 202 additionally determines whether there are additional commits within the VCS 108 for which to generate metadata structures.

In the illustrated example of FIG. 2, the API 202 additionally or alternatively acts as a user interface between users and the semantic search engine 102. For example, the API 202 monitors for user queries. The API 202 additionally or alternatively determines whether a query has been received. In response to determining that a query has been received, the API 202 determines whether the query includes a code snippet or an NL input. For example, the API 202 determines whether the user has selected a checkbox indicative of whether the query includes an NL input or a code snippet. The API 202 may employ additional or alternative techniques to determine whether a query includes an NL input or a code snippet. If the query includes an NL input, the API 202 forwards the query to the NL processor 204. If the query includes a code snippet, the API 202 forwards the query to the code classifier 206.

In some examples, the example API 202 implements example means for interfacing. The means for interfacing is implemented by executable instructions such as that implemented by at least blocks 1008, 1010, 1012, and 1024 of FIG. 10 and/or at least blocks 1102, 1104, 1106, 1128, 1132, and 1134 of FIG. 11. The executable instructions of blocks 1008, 1010, 1012, and 1024 of FIG. 10 and/or blocks 1102, 1104, 1106, 1128, 1132, and 1134 of FIG. 11 may be executed on at least one processor such as the example processor 1212 of FIG. 12. In other examples, the means for interfacing is implemented by hardware logic, hardware implemented state machines, logic circuitry, and/or any other combination of hardware, software, and/or firmware.

In the illustrated example of FIG. 2, the NL processor 204 is implemented by one or more processors executing instructions. Additionally or alternatively, the NL processor 204 can be implemented by one or more analog or digital circuit(s), logic circuits, programmable processor(s), programmable controller(s), GPU(s), DSP(s), ASIC(s), PLD(s) and/or FPLD(s). After the NLP model executed by the NL processor 204 is trained, the NL processor 204 determines whether various commits at the VCS 108 include comment and/or message parameters. The NL processor 204 processes the comment and/or message parameters corresponding to one or more commits extracted from the VCS 108. The NL processor 204 additionally determines the intent of the comment and message parameters and supplements the metadata structure stored in the database 106 for a given commit.

Additionally or alternatively, the NL processor 204 processes and determines the intent of NL queries. For example, the NL processor 204 is configured to extract NL features from and NL string. Additionally, the NL processor 204 is configured to process NL features to determine the intent of the NL string. In some examples, if the semantic meaning of two different NL queries are the same or sufficiently similar, the NL processor 204 will cause the database driver 208 to query the database 106 with the same query. As such, the database 106 may return the same results for different NL queries if the semantic meaning of the queries is sufficiently similar.

In some examples, the example NL processor 204 implements example means for processing natural language. The means for processing natural language is implemented by executable instructions such as that implemented by at least blocks 1014, 1016, 1018, 1020, and 1022 of FIG. 10 and/or at least blocks 1108, 1110, 1112, and 1114 of FIG. 11. The executable instructions of blocks 1014, 1016, 1018, 1020, and 1022 of FIG. 10 and/or blocks 1108, 1110, 1112, and 1114 of FIG. 11 may be executed on at least one processor such as the example processor 1212 of FIG. 12. In other examples, the means for processing natural language is implemented by hardware logic, hardware implemented state machines, logic circuitry, and/or any other combination of hardware, software, and/or firmware.

In the illustrated example of FIG. 2, the code classifier 206 is implemented by one or more processors executing instructions. Additionally or alternatively, the code classifier 206 can be implemented by one or more analog or digital circuit(s), logic circuits, programmable processor(s), programmable controller(s), GPU(s), DSP(s), ASIC(s), PLD(s) and/or FPLD(s). After the CC model executed by the code classifier 206 is trained, the code classifier 206 processes the code for commits at the VCS 108 that do not include comment and/or message parameters to determine the intent of the code. Additionally or alternatively, the code classifier 206 processes code snippet queries (e.g., uncommented and non-self-documented code snippets) to determine the intent of the queries. For example, the code classifier 206 is configured to extract and to process code snippet features to identify the intent of code. In some examples, the CC model may be trained to provide an expected intent for a certain code snippet.

In some examples, the example code classifier 206 implements example means for classifying code. The means for classifying code is implemented by executable instructions such as that implemented by at least blocks 1032, 1034, 1036, 1038, and 1040 of FIG. 10 and/or at least blocks 1116, 1118, 1120, and 1122 of FIG. 11. The executable instructions of blocks 1032, 1034, 1036, 1038, and 1040 of FIG. 10 and/or blocks 1116, 1118, 1120, and 1122 of FIG. 11 may be executed on at least one processor such as the example processor 1212 of FIG. 12. In other examples, the means for classifying code is implemented by hardware logic, hardware implemented state machines, logic circuitry, and/or any other combination of hardware, software, and/or firmware.

In the illustrated example of FIG. 2, the database driver 208 is implemented by one or more processors executing instructions. Additionally or alternatively, the database driver 208 can be implemented by one or more analog or digital circuit(s), logic circuits, programmable processor(s), programmable controller(s), GPU(s), DSP(s), ASIC(s), PLD(s) and/or FPLD(s). In the example of FIG. 2, the database driver 208 is implemented by the Neo4j Python Driver 4.1. In additional or alternative examples, the database driver 208 can be implemented by an ArangoDB Java driver, an OrientDB Spring Data driver, a Gremlin-Node driver, among others. In some examples, the database driver 208 can be implemented by a database interface, a database communicator, a semantic query generator, among others.

In the illustrated example of FIG. 2, the database driver 208 stores and/or updates metadata structures stored in the database 106 in response to inputs from the API 202, the NLP model executor 216, and/or the CC model executor 222. The database driver 208 additionally or alternatively queries the database 106 with the result generated by the NL processor 204 and/or the result generated by the code classifier 206. For example, when the query includes an NL input, the database driver 208 queries the database 106 with intent of the query and the NL features as determined by the NL processor 204. When the query includes a code snippet, the database driver 208 queries the database 106 with the intent of the code snippet as determined by the code classifier 206. In examples disclosed herein, the database driver 208 generates semantic queries to the database 106 in the Cypher query language. Other query languages may be used depending on the implementation of the database 106.

In the illustrated example of FIG. 2, the database driver 208 determines whether the database 106 returned any matches for a given query. In response to determining that the database 106 did not return any matches, the database driver 208 transmits a “no match” message to the API 202 to be presented to the user. For example, a “no match” message indicates to the user that the query did not result in a match and suggests that the user start their development from scratch. In response to determining that the database 106 returned one or more matches, the database driver 208 orders the results according to at least one of respective certainty or uncertainty parameters of the results. The database driver 208 additionally transmits the ordered results to the API 202 to be presented to the requesting user.

In some examples, the example database driver 208 implements example means for driving database access. The means for driving database access is implemented by executable instructions such as that implemented by at least blocks 1124, 1126, and 1130 of FIG. 11. The executable instructions of blocks 1124, 1126, and 1130 of FIG. 11 may be executed on at least one processor such as the example processor 1212 of FIG. 12. In other examples, the means for driving database access is implemented by hardware logic, hardware implemented state machines, logic circuitry, and/or any other combination of hardware, software, and/or firmware.

In the illustrated example of FIG. 2, the model trainer 210 is implemented by one or more processors executing instructions. Additionally or alternatively, the model trainer 210 can be implemented by one or more analog or digital circuit(s), logic circuits, programmable processor(s), programmable controller(s), GPU(s), DSP(s), ASIC(s), PLD(s) and/or FPLD(s). In the example of FIG. 2, the model trainer 210 trains the NLP model and/or the CC model.

In the illustrated example of FIG. 2, the model trainer 210 trains the NLP model to determine the intent of comment and/or message parameters of commits. In examples disclosed herein, the model trainer 210 trains the NLP model using an adaptive learning rate optimization algorithm known as “Adam.” The “Adam” algorithm executes an optimized version of stochastic gradient descent. However, any other training algorithm may additionally or alternatively be used. In examples disclosed herein, training is performed until the NLP model returns the intent of comment and/or message parameters with an average certainty greater than 97% and/or an average uncertainty less than 15%. In examples disclosed herein, training is performed at the semantic search engine 102. However, in additional or alternative examples (e.g., when the user device 110 executes a plugin to implement the semantic search engine 102), the training may be performed at the user device 110 and/or any other end-user device.

In examples disclosed herein, training of the NLP model is performed using hyperparameters that control how the learning is performed (e.g., a learning rate, a number of layers to be used in the machine learning model, etc.). In examples disclosed herein, hyperparameters control the number of layers of the NLP model, the number of samples in the training data, among others. Such hyperparameters are selected by, for example, manual selection. For example, the hyperparameters can be adjusted when there is greater uncertainty than certainty in the network. In some examples re-training may be performed. Such re-training may be performed periodically and/or in response to a trigger event, such as detecting that the average certainty for intent detection has fallen below 97% and/or that the average uncertainty for intent detection has risen above 15%. Other events may trigger re-training.

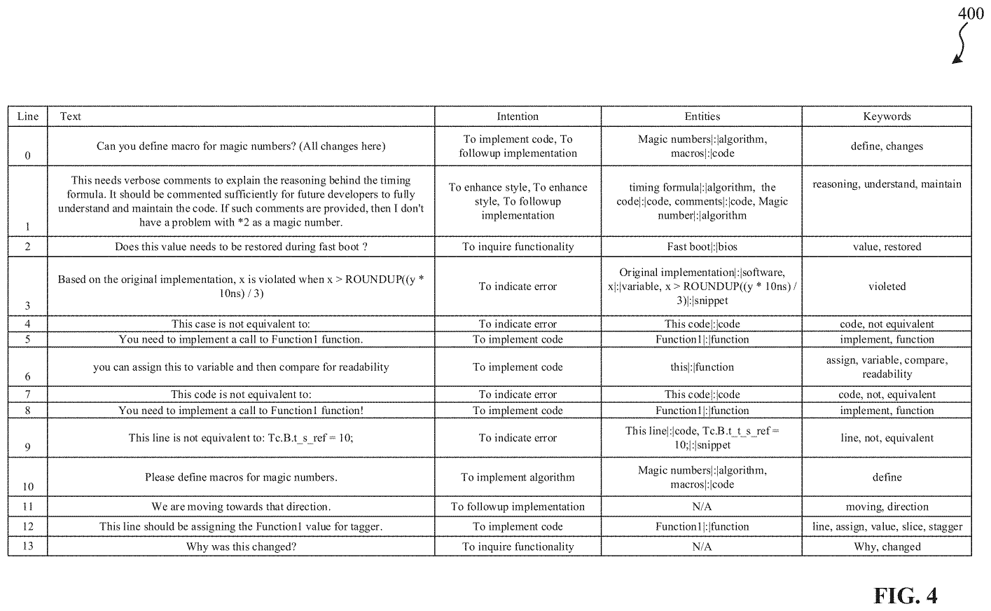

Training is performed using training data. In examples disclosed herein, the training data for the NLP model originates from locally generated data. However, in additional or alternative examples, publicly available training data could be used to train the NLP model. Additional detail of the training data for the NLP model is discussed in connection with FIG. 4. Because supervised training is used, the training data is labeled. Labeling is applied to the training data for the NLP model by an individual supervising the training of the NLP model. In some examples, the NLP model training data is preprocessed to, for example, extract features such as keywords and entities to facilitate NLP of the training data.

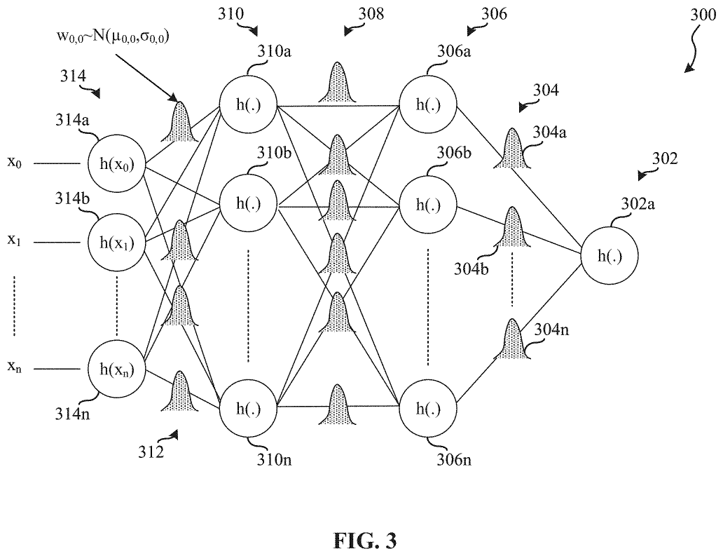

Once training is complete, the NLP model is deployed for use as an executable construct that processes an input and provides an output based on the network of nodes and connections defined in the NLP model. Example structure of the NLP model is illustrated and discussed in connection with FIG. 3. The NLP model is stored at the semantic search engine 102. The NLP model may then be executed by the NLP model executor 216. In some examples, one or more processors of the user device 110 execute the NLP model.

In the illustrated example of FIG. 2, the model trainer 210 trains the CC model to determine the intent of code snippet queries. In examples disclosed herein, the model trainer 210 trains the CC model using an adaptive learning rate optimization algorithm known as “Adam.” The “Adam” algorithm executes an optimized version of stochastic gradient descent. However, any other training algorithm may additionally or alternatively be used. In examples disclosed herein, training is performed until the CC model returns the intent of a code snippet with an average certainty greater than 97% and/or an average uncertainty less than 15%. In examples disclosed herein, training is performed at the semantic search engine 102. However, in additional or alternative examples (e.g., when the user device 110 executes a plugin to implement the semantic search engine 102), the training may be performed at the user device 110 and/or any other end-user device.

In examples disclosed herein, training of the CC model is performed using hyperparameters that control how the learning is performed (e.g., a learning rate, a number of layers to be used in the machine learning model, etc.). In examples disclosed herein, hyperparameters control the number of layers of the CC model, the number of samples in the training data, among others. Such hyperparameters are selected by, for example, manual selection. For example, the hyperparameters can be adjusted when there is greater uncertainty than certainty in the network. In some examples re-training may be performed. Such re-training may be performed periodically and/or in response to a trigger event, such as detecting that the average certainty for intent detection has fallen below 97% and/or the average uncertainty has risen above 15%. Other trigger events may cause retraining.

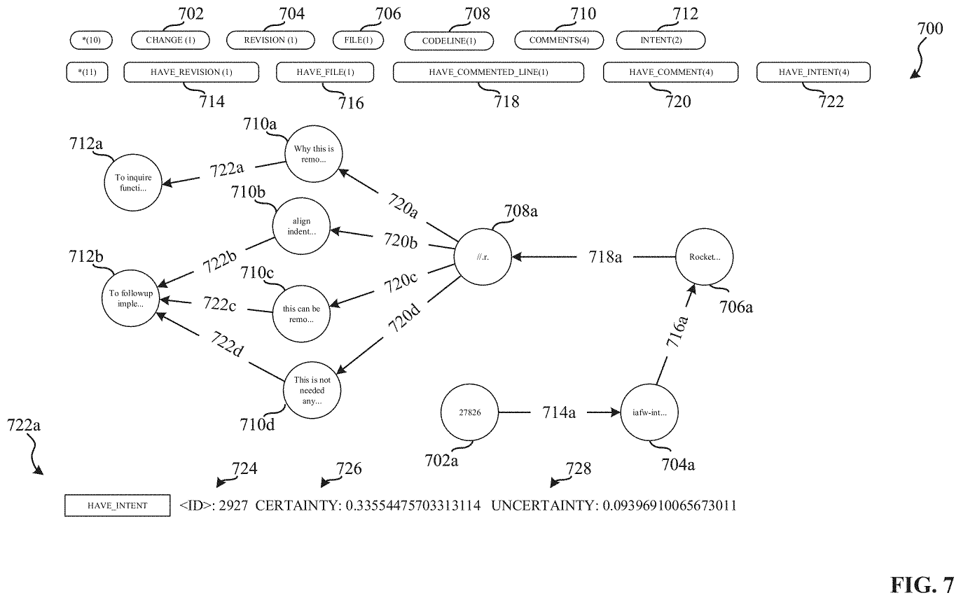

Training is performed using training data. In examples disclosed herein, the training data for the CC model is generated based on the output of the trained NLP model. For example, the NLP model executor 216 executes the NLP model to determine the intent of comment and/or message parameters for various commits of the VCS 108. The NLP model executor 216 then supplements metadata structures for the commits with the intent. However, in additional or alternative examples, the NLP model may process publicly available training data to generate training data for the CC model. Additional detail of the training data for the CC model is discussed in connection with FIGS. 7 and/or 8. Because supervised training is used, the training data is labeled. Labeling is applied to the training data for the CC model by the NLP model and/or manually based on the keywords, entities, and/or intents identified by the NLP model. In some examples, the CC model training data is pre-processed to, for example, extract features such as tokens of the code snippet and/or abstract syntax tree (AST) features to facilitate classification of the code snippet.

Once training is complete, the CC model is deployed for use as an executable construct that processes an input and provides an output based on the network of nodes and connections defined in the CC model. Example structure of the CC model is illustrated and discussed in connection with FIG. 3. The CC model is stored at the semantic search engine 102. The CC model may then be executed by the CC model executor 222. In some examples, one or more processors of the user device 110 execute the CC model.

Once trained, the deployed model(s) may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

In some examples, the example model trainer 210 implements example means for training machine learning models. The means for training machine learning models is implemented by executable instructions such as that implemented by at least blocks 1002, 1004, 1006, 1026, 1028, and 1030 of FIG. 10. The executable instructions of blocks 1002, 1004, 1006, 1026, 1028, and 1030 of FIG. 10 may be executed on at least one processor such as the example processor 1212 of FIG. 12. In other examples, the means for training machine learning models is implemented by hardware logic, hardware implemented state machines, logic circuitry, and/or any other combination of hardware, software, and/or firmware.

In the illustrated example of FIG. 2, the NL preprocessor 212 is implemented by one or more processors executing instructions. Additionally or alternatively, the NL preprocessor 212 can be implemented by one or more analog or digital circuit(s), logic circuits, programmable processor(s), programmable controller(s), GPU(s), DSP(s), ASIC(s), PLD(s) and/or FPLD(s). In the example of FIG. 2, the NL preprocessor 212 preprocesses NL queries, comment parameters, and/or message parameters. For example, the NL preprocessor 212 separates the text of NL queries, comment parameters, and/or message parameters into words, phrases, and/or other units. In some examples, the NL preprocessor 212 determines whether a commit at the VCS 108 includes comment and/or message parameters by accessing the VCS 108 and/or based on data received from the API 202.

In some examples, the example NL preprocessor 212 implements example means for preprocessing natural language. The means for preprocessing natural language is implemented by executable instructions such as that implemented by at least blocks 1014 and 1016 of FIG. 10 and/or at least block 1108 of FIG. 11. The executable instructions of blocks 1014 and 1016 of FIG. 10 and/or block 1108 of FIG. 11 may be executed on at least one processor such as the example processor 1212 of FIG. 12. In other examples, the means for preprocessing natural language is implemented by hardware logic, hardware implemented state machines, logic circuitry, and/or any other combination of hardware, software, and/or firmware.

In the illustrated example of FIG. 2, the NL feature extractor 214 is implemented by one or more processors executing instructions. Additionally or alternatively, the NL feature extractor 214 can be implemented by one or more analog or digital circuit(s), logic circuits, programmable processor(s), programmable controller(s), GPU(s), DSP(s), ASIC(s), PLD(s) and/or FPLD(s). In the example of FIG. 2, the NL feature extractor 214 extracts and/or otherwise generates features from the preprocessed NL queries, comment parameters, and/or message parameters. For example, the NL feature extractor 214 generates tokens for keywords and/or entities of the preprocessed NL queries, comment parameters, and/or message parameters. For example, tokens represent the words in the NL queries, the comment parameters, and/or the message parameters and/or the vocabulary therein.

In additional or alternative examples, the NL feature extractor 214 generates parts of speech (PoS) and/or dependency (Deps) features from the preprocessed NL queries, comment parameters, and/or message parameters. PoS features represent labels for the tokens (e.g., noun, verb, adverb, adjective, preposition, etc.). Deps features represent dependencies between tokens within the NL queries, comment parameters, and/or message parameters. The NL feature extractor 214 additionally embeds the tokens to create an input vector representative of all the tokens extracted from a given NL query, comment parameter, and/or message parameter. The NL feature extractor 214 also embeds the PoS features to create an input vector representative of the type of the words (e.g., noun, verb, adverb, adjective, preposition, etc.) represented by the tokens in the NL query, the comment parameter, and/or the message parameter. The NL feature extractor 214 additionally embeds the Deps features to create an input vector representative of the relation between raw tokens in the NL query, the comment parameter, and/or the message parameter. The NL feature extractor 214 merges the token input vector, the PoS input vector, and the Deps input vector to create a more generalized input vector to the NLP model that allows the NLP model to better identify the intent of natural language in any natural language domain.

In some examples, the example NL feature extractor 214 implements example means for extracting natural language features. The means for extracting natural language features is implemented by executable instructions such as that implemented by at least block 1018 of FIG. 10 and/or at least block 1110 of FIG. 11. The executable instructions of block 1018 of FIG. 10 and/or block 1110 of FIG. 11 may be executed on at least one processor such as the example processor 1212 of FIG. 12. In other examples, the means for extracting natural language features is implemented by hardware logic, hardware implemented state machines, logic circuitry, and/or any other combination of hardware, software, and/or firmware.

In the illustrated example of FIG. 2, the NLP model executor 216 is implemented by one or more processors executing instructions. Additionally or alternatively, the NLP model executor 216 can be implemented by one or more analog or digital circuit(s), logic circuits, programmable processor(s), programmable controller(s), GPU(s), DSP(s), ASIC(s), PLD(s) and/or FPLD(s). In the example of FIG. 2, the NLP model executor 216 executes the NLP model described herein.

In the illustrated example of FIG. 2, the NLP model executor 216 executes a BNN model. In additional or alternative examples, the NLP model executor 216 may execute different types of machine learning models and/or machine learning architectures exist. In examples disclosed herein, using a BNN model enables the NLP model executor 216 to determine certainty and/or uncertainty parameters when processing NL queries, comment parameters, and/or message parameters. In general, machine learning models/architectures that are suitable to use in the example approaches disclosed herein will include probabilistic computing techniques.

In some examples, the example NLP model executor 216 implements example means for executing NLP models. The means for executing NLP models is implemented by executable instructions such as that implemented by at least blocks 1020 and 1022 of FIG. 10 and/or at least blocks 1112 and 1114 of FIG. 11. The executable instructions of bl blocks 1020 and 1022 of FIG. 10 and/or blocks 1112 and 1114 of FIG. 11 may be executed on at least one processor such as the example processor 1212 of FIG. 12. In other examples, the means for executing NLP models is implemented by hardware logic, hardware implemented state machines, logic circuitry, and/or any other combination of hardware, software, and/or firmware.

In the illustrated example of FIG. 2, the code preprocessor 218 is implemented by one or more processors executing instructions. Additionally or alternatively, the code preprocessor 218 can be implemented by one or more analog or digital circuit(s), logic circuits, programmable processor(s), programmable controller(s), GPU(s), DSP(s), ASIC(s), PLD(s) and/or FPLD(s). In the example of FIG. 2, the code preprocessor 218 preprocesses code snippet queries and/or code from the VCS 108 without comment and/or message parameters. For example, the code preprocessor 218 converts code snippets into text and separates the text into words, phrases, and/or other units.

In some examples, the example code preprocessor 218 implements example means for preprocessing code. The means for preprocessing code is implemented by executable instructions such as that implemented by at least blocks 1032 and 1040 of FIG. 10 and/or at least block 1116 of FIG. 11. The executable instructions of blocks 1032 and 1040 of FIG. 10 and/or block 1116 of FIG. 11 may be executed on at least one processor such as the example processor 1212 of FIG. 12. In other examples, the means for preprocessing code is implemented by hardware logic, hardware implemented state machines, logic circuitry, and/or any other combination of hardware, software, and/or firmware.

In the illustrated example of FIG. 2, the code feature extractor 220 is implemented by one or more processors executing instructions. Additionally or alternatively, the code feature extractor 220 can be implemented by one or more analog or digital circuit(s), logic circuits, programmable processor(s), programmable controller(s), GPU(s), DSP(s), ASIC(s), PLD(s) and/or FPLD(s). In the example of FIG. 2, the code feature extractor 220 implements an abstract syntax tree (AST) to extract and/or otherwise generate features from the preprocessed code snippet queries and/or code from the VCS 108 without comment and/or message parameters. For example, the code feature extractor 220 generates tokens and parts of code (PoC) features. Tokens represent the words, phrases, and/or other units in the code and/or the syntax therein. The PoC features represent enhanced labels, generated by the AST, for the tokens. The code feature extractor 220 additionally or alternatively identifies a type of the tokens (e.g., as determined by the AST). Together, the PoC tokens and token type features generate at least two sequences of features to be used as inputs for the CC model.

In the illustrated example of FIG. 2, the code feature extractor 220 additionally embeds the tokens to create an input vector representative of all the tokens extracted from a given code snippet query and/or code from a commit at the VCS 108. The code feature extractor 220 also embeds the PoC features to create an input vector representative of the type of the words (e.g., variable, operator, etc.) represented by the tokens in the code snippet query and/or code from a commit at the VCS 108. The code feature extractor 220 merges the token input vector and the PoC input vector to create a more generalized input vector to the CC model that allows the CC model to better identify the intent of code in any programming language domain. For example, to train the CC model to determine the intent of code in any programming language domain, the model trainer 210 trains the CC model with a training dataset that includes ASTs of a code snippet but in the various programming languages that a user or the model trainer 210 desires the CC model to understand.

In some examples, the example code feature extractor 220 implements example means for extracting code features. The means for extracting code features is implemented by executable instructions such as that implemented by at least block 1034 of FIG. 10 and/or at least block 1118 of FIG. 11. The executable instructions of block 1034 of FIG. 10 and/or block 1118 of FIG. 11 may be executed on at least one processor such as the example processor 1212 of FIG. 12. In other examples, the means for extracting code features is implemented by hardware logic, hardware implemented state machines, logic circuitry, and/or any other combination of hardware, software, and/or firmware.

In the illustrated example of FIG. 2, the CC model executor 222 is implemented by one or more processors executing instructions. Additionally or alternatively, the CC model executor 222 can be implemented by one or more analog or digital circuit(s), logic circuits, programmable processor(s), programmable controller(s), GPU(s), DSP(s), ASIC(s), PLD(s) and/or FPLD(s). In the example of FIG. 2, the CC model executor 222 executes the CC model described herein.

In the illustrated example of FIG. 2, the CC model executor 222 executes a BNN model. In additional or alternative examples, the CC model executor 222 may execute different types of machine learning models and/or machine learning architectures exist. In examples disclosed herein, using a BNN model enables the CC model executor 222 to determine certainty and/or uncertainty parameters when processing code snippet queries and/or code from commits at the VCS 108. In general, machine learning models/architectures that are suitable to use in the example approaches disclosed herein will include probabilistic computing techniques.

In some examples, the example CC model executor 222 implements example means for executing CC models. The means for executing CC models is implemented by executable instructions such as that implemented by at least blocks 1036 and 1038 of FIG. 10 and/or at least blocks 1120 and 1122 of FIG. 11. The executable instructions of blocks 1036 and 1038 of FIG. 10 and/or blocks 1120 and 1122 of FIG. 11 may be executed on at least one processor such as the example processor 1212 of FIG. 12. In other examples, the means for executing CC models is implemented by hardware logic, hardware implemented state machines, logic circuitry, and/or any other combination of hardware, software, and/or firmware.

FIG. 3 is a schematic illustration of an example topology of a Bayesian neural network (BNN) 300 that may implement the NLP model and/or the CC model executed by the semantic search engine 102 of FIGS. 1 and/or 2. In the example of FIG. 3, the BNN 300 includes an example input layer 302, example hidden layers 306 and 310, and an example output layer 314. The example input layer 302 includes an example input neuron 302a, the example hidden layer 306 includes example hidden neurons 306a, 306b, and 306n, example hidden layer 310 includes example hidden neurons 310a, 310b, and 310n, and the example output layer 314 includes example neurons 314a, 314b, and 314n. In the example of FIG. 3, each of the input neuron 302a, hidden neurons 306a, 306b, 306n, 310a, 310b, 310n, and output neurons 314a, 314b, and 314n process inputs according to an activation function h(x).

In the illustrated example of FIG. 3, the BNN 300 is an artificial neural network (ANN) where the weights between the layers (e.g., 302, 306, 310, and 314) are defined via distributions. For example, the input neuron 302a is coupled to the hidden neurons 306a, 306b, and 306n and weights 304a, 304b, and 304n are applied to the output of the input neuron 302a, respectively, according to probability distribution functions (PDFs). Similarly, weights 308 are applied to the outputs of the hidden neurons 306a, 306b, and 306n and weights 312 are applied to the outputs of the hidden neurons 310a, 310b, and 310n.

In the illustrated example of FIG. 3, each of the PDFs describing the weights 304, 308, and 312 are defined according to equation 1 below.

w_{0,0}˜N(μ_{0,0},σ_{0,0}) Equation 1

In the example of Equation 1, weights (w) are defined as a normal distribution for a given mean (μ) and a given standard deviation (σ). Accordingly, during the inferencing phase, samples are generated from the probability-weight distributions to obtain a “snapshot” of weights to apply to the outputs of neurons. The propagation or forward pass of data through the BNN 300 is executed according to this “snapshot.” The propagation of data through the BNN 300 is executed multiple times (e.g., around 20-40 trials or even more) depending on the target certainty and/or uncertainty for a given application.

FIG. 4 is a graphical illustration of example training data 400 to train the NLP model executed by the semantic search engine 102 of FIGS. 1 and/or 2. The training data 400 represents a training dataset for probabilistic intent detection by the NL processor 204. The training data 400 includes five columns that specify a LOC, the text of example comment and/or message parameters applied to that LOC, the intention of the example comment and/or message parameters, the entities of the example comment and/or message parameters, and the keywords of the example comment and/or message parameters.

In the illustrated example of FIG. 4, the NLP model executor 216 combines the entities and keywords of the comment and/or message parameters of the LOC (e.g., extracted by the NL feature extractor 214) with the intent detection (e.g., determined by the NLP model executor 216) to determine an improved semantic interpretation of the text. In the training data 400, the intentions for comment and/or message parameters include “To answer functionality,” “To indicate error,” “To inquire functionality,” “To enhance functionality,” “To call a function,” “To implement code,” “To inquire implementation,” “To follow up implementation,” “To enhance style,” and “To implement algorithm.”

In the illustrated example of FIG. 4, for the first LOC (illustrated with zero indexing), the text of the comment and/or message parameters is “Can you define macro for magic numbers? (All changes here).” Magic numbers refer to unique values with unexplained meaning and/or multiple occurrences that could be replaced by named constants. The intention of the comment and/or message parameters on the first LOC is “To implement code” and “To follow up implementation.” The entities of the comment and/or message parameters on the first LOC are “Magic numbers|:|algorithm, macros|:|code.” The keywords of the comment and/or message parameters of the first LOC are “define, changes.”

In the illustrated example of FIG. 4, for a small dataset (e.g., 250 samples) in a minimal Linux virtual environment, the model trainer 210 trains the NLP model in 36.5 seconds and 30 iterations. In the example of FIG. 4, when operating in the inference phase, the NLP model performs inferences with an execution time of 1.6 seconds for 10 passes for a single input. For example, the NLP model processes the sentence “default is non-zero.” The mean of the 10 passes and the standard deviation of the test sentence “default is non-zero” are represented in Table 1.

TABLE 1

| Mean | Standard Deviation |
|---|---|
| 0.073 | 0.097 |
| 0.071 | 0.105 |
| 0.050 | 0.122 |
| 0.105 | 0.085 |
| −0.066 | 0.105 |
| −0.017 | 0.063 |
| −0.018 | 0.116 |
| 0.033 | 0.102 |
| 0.010 | 0.105 |
| 0.716 | 0.095 |

In the illustrated example of FIG. 4, the NLP model assigns the label of “To follow up implementation,” to the test sentence which is the correct class. Based on these results, examples disclosed herein achieve sufficient accuracy and reduced (e.g., low) uncertainty with increased (e.g., greater than or equal to 250) training samples.

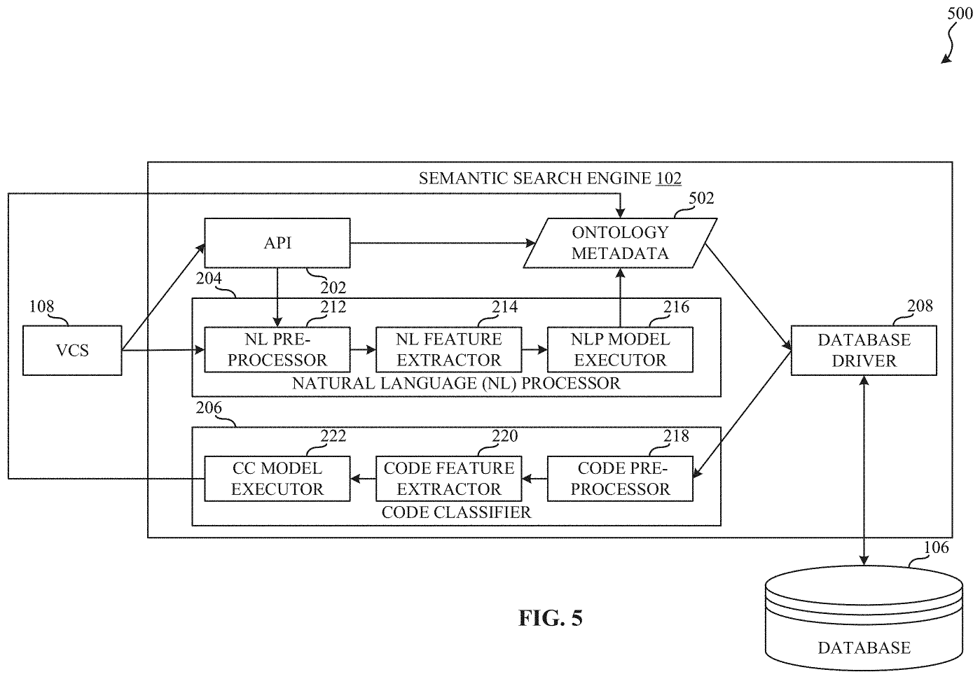

FIG. 5 is a block diagram illustrating an example process 500 executed by the semantic search engine 102 of FIGS. 1 and/or 2 to generate example ontology metadata 502 from the VCS 108 of FIG. 1. The process 500 illustrates three pipelines that are executed to generate the ontology metadata 502. The three pipelines include metadata generation, natural language processing, and uncommented code classifying. In the example of FIG. 5, the metadata generation pipeline begins when the API 202 extracts relevant information from the VCS 108. The API 202 additionally generates a metadata structure (e.g., 502) that is usable by the database driver 208. In the example of FIG. 5, the API 202 extracts change parameters, subject parameters, message parameters, revision parameters, file parameters, code line parameters, comment parameters, and/or diff parameters for commits in the VCS 108.

In the illustrated example of FIG. 5, the natural language processing pipeline is a probabilistic deep learning pipeline that may be executed by the semantic search engine 102 to determine the probability distribution that a comment and/or message parameter corresponds to a particular intent (e.g., development intent). The natural language processing pipeline begins when the NL preprocessor 212 determines whether a given commit includes comment and/or message parameters. If the commit includes comment and/or message parameters, the NL preprocessor 212 preprocesses the comment and/or message parameters of the commit in the VCS 108 by separating the text of the comment and/or message parameters into words, phrases, and/or other units. Subsequently, the NL feature extractor 214 extracts NL features from the comment and/or message parameters by generates tokens for keywords and/or entities of the preprocessed comment and/or message parameters. Additionally or alternatively, the NL feature extractor 214 generates PoS and Deps features from the preprocessed comment and/or message parameters and merges the tokens, PoS features, and Deps features.

In the illustrated example of FIG. 5, the NLP model executor 216 (e.g., executing the trained NLP model) combines the extracted NL features with the intent of the comment and/or message parameters and supplements the ontology metadata 502. For example, the NLP model executor 216 determines certainty and/or uncertainty parameters that are to accompany the ontology for code including comment and/or message parameters. Accordingly, the NLP model executor 216 generates a probabilistic distribution model of natural language comments and/or messages relating the comments and/or messages to the respective development intent of the comments and/or messages.

In the illustrated example of FIG. 5, the supplemented ontology metadata 502 may then be used by the model trainer 210 in an offline process (not illustrated) to train the code classifier 206. In the example of FIG. 5, a human supervisor and/or a program, both referred to generally as an administrator, may query the semantic search engine 102 with one or more NL queries including a known intent and/or a known related code snippet. Subsequently, the NLP model executor 216 and/or the administrator, using the output of the NLP model executor 216, may associate the output of the semantic search engine 102 with the intent of the NL query, keywords of the NL query, entities of the NL query, and/or related revisions (e.g., subsequent commits) of the expected code output. The NLP model executor 216 and/or the administrator labels the intent of code snippets retrieved from the VCS 108 by combining intent for comment and/or message parameters such as “To implement algorithm,” “To implement code,” and/or “To call a function,” with entities such as “Magic number” and/or “Function1.” Based on such combinations, the NLP model executor 216 and/or the administrator generates labels for code such as “To implement Magic number” and/or “To call Function1.” The NLP model executor 216 and/or the administrator generates additional or alternative labels for the code retrieved from the VCS 108 based on additional or alternative intents, keywords, and/or entities. The NLP model executor 216 and/or the administrator may repeat this process to generate additional data for a training dataset for the CC model.

In the illustrated example of FIG. 5, the uncommented code classifying pipeline begins when the code preprocessor 218 preprocesses code for commits at the VCS 108 that do not include comment and/or message parameters. For example, the code preprocessor 218 extracts the code line parameter from the ontology metadata 502 initially generated by the API 202 for the commits lacking comment and/or message parameters. For example, the code preprocessor 218 preprocesses the code by converting the code into text and separating the text into words, phrases, and/or other units. Subsequently, the code feature extractor 220 generates features vectors from the preprocessed code by generating tokens for words, phrases, and/or other units of the preprocessed code. Additionally or alternatively, the code feature extractor 220 generates PoC features. The code feature extractor 220 additionally or alternatively identifies a type of the tokens (e.g., as determined by the AST).

In the illustrated example of FIG. 5, the CC model executor 222 then executes the trained CC model to identify the intent of code snippets without the assistance of comments and/or self-documentation. For example, the CC model executor 222 determines certainty and/or uncertainty parameters that are to accompany the ontology for code that does not include comment and/or message parameters. Accordingly, the CC model executor 222 generates a probabilistic distribution model of uncommented and/or non-self-documented code relating the code to the development intent of the code. As such, when a user runs a NL query using the semantic search engine 102, the semantic search engine 102 runs the query against the code (with identified intent) to return a listing of code with intents related to that of the NL query.

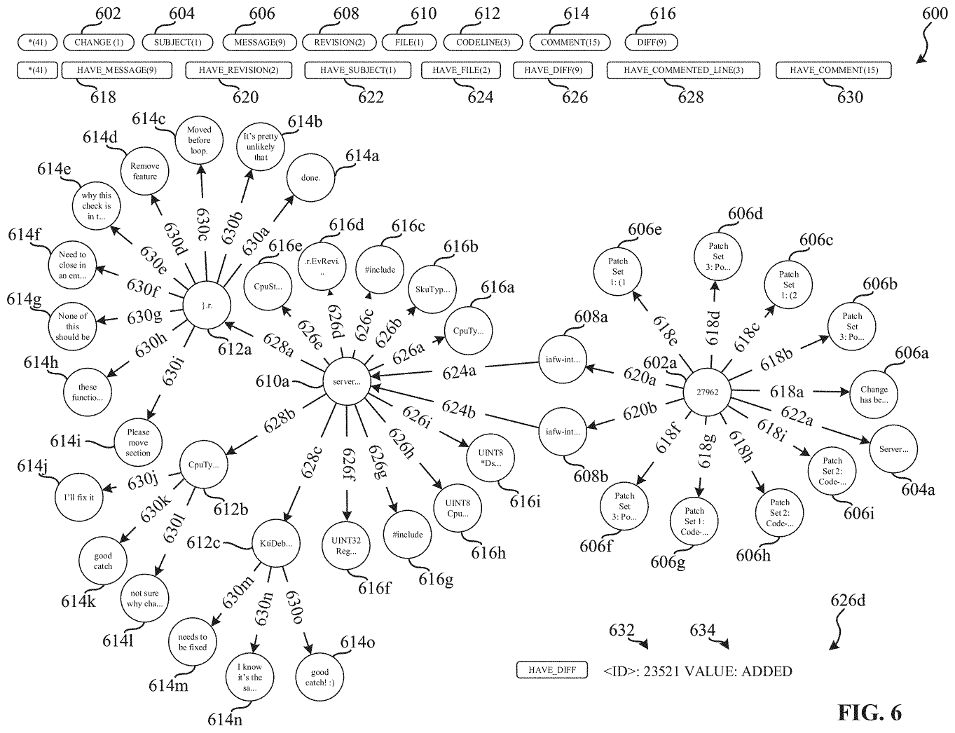

FIG. 6 is a graphical illustration of example ontology metadata 600 generated by the API 202 of FIGS. 2 and/or 5 for a commit including comment and/or message parameters. The ontology metadata 600 represents example change parameters 602, example subject parameters 604, example message parameters 606, example revision parameters 608, example file parameters 610, example code line parameters 612, example comment parameters 614, and example diff parameters 616. The change parameters 602, subject parameters 604, message parameters 606, revision parameters 608, file parameters 610, code line parameters 612, comment parameters 614, and diff parameters 616 are represented as nodes in the ontology metadata 600. The ontology metadata 600 illustrates a portion of the ontology of the VCS 108. For example, the ontology metadata 600 represents the entities related to a single change 602a. Because the ontology metadata 600 is accessible within the database 106 via the Cypher query language, the semantic search engine 102 can query the entities related to a single change.

In the illustrated example of FIG. 6, the relationships between the parameters 602, 604, 606, 608, 610, 612, 614, and 616 are represented by edges. For example, the ontology metadata 600 includes example Have_Message edges 618, example Have_Revision edges 620, example Have_Subject edges 622, example Have_File edges 624, example Have_Diff edges 626, example Have_Commented_Line edges 628, and example Have_Comment edges 630. In the example of FIG. 6, each edge includes an identity (ID) parameter and a value parameter. For example, Have_Diff edge 626d includes an example ID parameter 632 and an example value parameter 634. The ID parameter 632 is equal to 23521 and the value parameter 634 is equal to “Added.” The ID parameter 632 and the value parameter 634 indicate that the Diff parameter 616d was added to the previous implementation. Typically, developers include comments in code that are related to a single line of code, due to habits of the reviewers and/or developers. The Diff parameters 616 and the corresponding Have_Diff edges 626 (e.g., Have_Diff edge 626d between the Diff parameter 616d and the File parameter 610a) allow the semantic search engine 102 to identify more code (e.g., greater than one LOC) to relate to the intent of comments and/or messages added by reviewers and/or developers.

FIG. 7 is a graphical illustration of example ontology metadata 700 stored in the database 106 of FIGS. 1 and/or 5 after the NL processor 204 of FIGS. 2 and/or 5 has identified the intent associated with one or more comment and/or message parameters of a commit in the VCS 108 of FIGS. 1 and/or 5. The ontology metadata 700 represents example change parameters 702, example revision parameters 704, example file parameters 706, example code line parameters 708, example comment parameters 710, and example intent parameters 712. The change parameters 702, revision parameters 704, file parameters 706, code line parameters 708, comment parameters 710, and intent parameters 712 are represented as nodes in the ontology metadata 700. The ontology metadata 700 illustrates a simplified metadata structure after the NLP model executor 216 combines initial metadata (e.g., as extracted by the API 202) with one or more development intents for code line comment and/or message parameters.

In the illustrated example of FIG. 7, the relationships between the parameters 702, 704, 706, 708, 710, and 712 are represented by edges. For example, the ontology metadata 700 includes example Have_Revision edges 714, example Have_File edges 716, example Have_Commented_Line edges 718, example Have_Comment edges 720, and example Have_Intent edges 722. In the example of FIG. 7, each Have_Intent edge 722 includes an ID parameter, a certainty parameter, and an uncertainty parameter. For example, Have_Intent edge 722a includes an example ID parameter 724, an example certainty parameter 726, and an example uncertainty parameter 728. The ID parameter 724 is equal to 2927, the certainty parameter 726 is equal to 0.33554475703313114, and the uncertainty parameter 728 is equal to 0.09396910065673011.

In the illustrated example of FIG. 7, the value of the comment parameter 710a is “Why this is removed?” and the value of the intent parameter 712a is “To inquire functionality.” Thus, the Have_Intent edge 722a between the comment parameter 710a and the intent parameter 712a illustrates the relationship between the two nodes. The certainty and uncertainty parameters 726, 728 are determined by the NLP model executor 216. By adding the PDF of the intent of the comment and/or message parameters, the NLP model executor 216 effectively assigns a probability of the intent of a code snippet related to the comment and/or message parameters. Thus, the NLP model executor 216 may (e.g., individually and/or with the assistance of an administrator) augment the metadata structures stored in the database 106 to generate a training dataset for the code classifier 206.

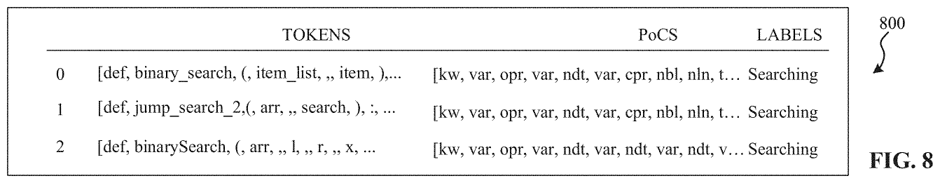

FIG. 8 is a graphical illustration of example features 800 to be processed by the example CC model executor 222 of FIGS. 2 and/or 5 to train the CC model. For example, the features 800 represent a code intent detection dataset. The code feature extractor 220 extracts the features 800 via an AST and generates one or more tokens with an identified token type. Additionally or alternatively, the code feature extractor 220 extracts PoC features. In this manner, the code feature extractor 220 generates at least two sequences of features that are input to the CC model executed by the CC model executor 222 (e.g., for the embedded layers).

In the illustrated example of FIG. 8, an administrator may query the semantic search engine 102 with one or more NL queries including a known intent and/or a known related code snippet. Subsequently, the NLP model executor 216 and/or the administrator, using the output of the NLP model executor 216, may associate the output of the semantic search engine 102 with the intent of the NL query, keywords of the NL query, entities of the NL query, and/or related revisions (e.g., subsequent commits) of the expected code output. The NLP model executor 216 and/or the administrator labels the intent of code snippets retrieved from the VCS 108 by combining intent for comment and/or message parameters with entities.

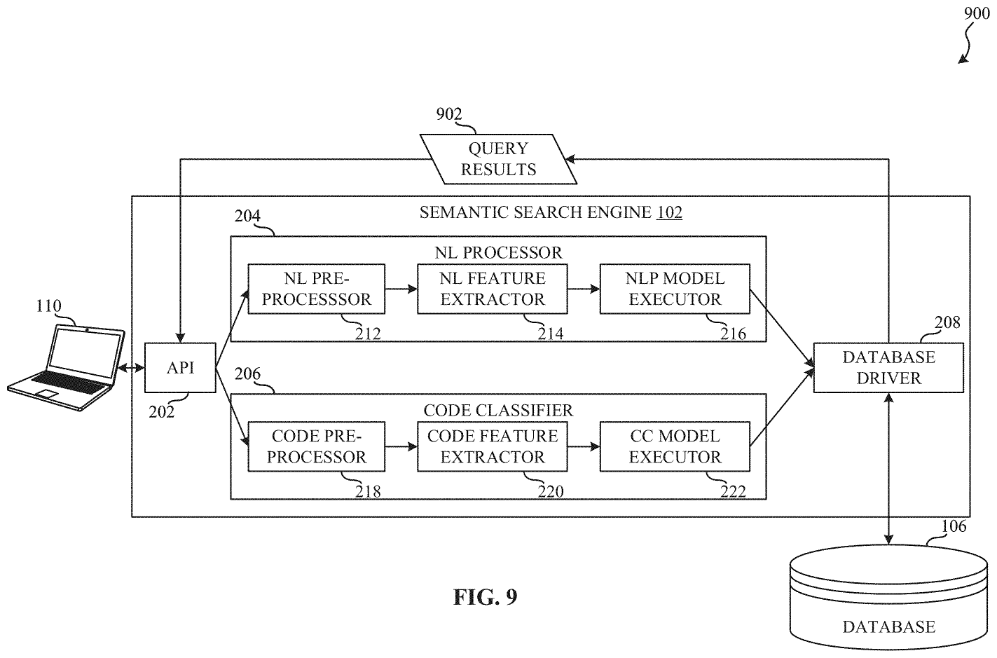

FIG. 9 is a block diagram illustrating an example process 900 executed by the semantic search engine 102 of FIGS. 1 and/or 2 to process queries from the user device 110 of FIG. 1. The process 900 illustrates the semantic search process facilitated by the semantic search engine 102. The process 900 can be initiated after both the NLP model and CC model have been trained and deployed. For example, after the NLP model and the CC model have been trained, the semantic search engine 102 generates an ontology for the VCS 108. The semantic search engine 102 handles both NL queries including text representative of a developer's inquiry and/or a raw code snippet (e.g., a code snippet that is uncommented and/or non-self-documented).

In the illustrated example of FIG. 9, the process 900 illustrates two pipelines that are executed to extract the meaning of a query to be used by the database driver 208 to generate a semantic query to the database 106. The two pipelines include natural language processing and uncommented code classifying. In the example of FIG. 9, the API 202 hosts an interface through which a user submits queries. For example, the API 202 hosts a web interface.

In the illustrated example of FIG. 9, the API 202 monitors the interface for a user query. In response to detecting a query, the API 202 determines whether the query includes a code snippet or a NL input. In response to determining that the query includes an NL input, the API 202 forwards the query to the NL processor 204. In response to determining that the query includes a code snippet, the API 202 forwards the query to the code classifier 206.

In the illustrated example of FIG. 9, when a user (e.g., developer) sends an NL query to the semantic search engine 102 for consulting the ontology (e.g., represented as at least the ontology metadata 600 and/or the ontology metadata 700) stored in the database 106, the NL processor 204 detects the intent of the text and extracts NL features (e.g., entities and/or keywords) to complete entries of a parameterized semantic query (e.g., in the Cypher query language). For example, the NL preprocessor 212 separates the text of NL queries into words, phrases, and/or other units. Additionally or alternatively, the NL feature extractor 214 extracts and/or otherwise generates features from the preprocessed NL queries by generating tokens for keywords and/or entities of the preprocessed NL queries and/or generating PoS and Deps features from the preprocessed NL queries. The NL feature extractor 214 merges the tokens, PoS, and Deps features. Subsequently, the NLP model executor 216 determines the intent of the NL queries and provides the intent and extracted NL features to the database driver 208.

In the illustrated example of FIG. 9, the database driver 208 queries the database 106 with the intent and extracted NL features. The database driver 208 determines whether the database 106 returned any matches with a threshold level of uncertainty. For example, when the database driver 208 queries the database 106, the database driver 208 specifies a threshold level of uncertainty above which the database 106 should not return results or, alternatively, return an indication that there are no results. For example, lower uncertainty in a result corresponds to a more accurate result and higher uncertainty in a result corresponds to a less accurate result. As such, the certainty and/or uncertainty parameters with which the NLP model executor 216 determines the intent is included in the query. If the database 106 returns matching of code snippets, the database driver 208 orders the results according to the certainty and/or the uncertainty parameters included therewith. Subsequently, the database driver 208 returns the query results 902 which include a set of code snippets matching the semantic query parameters. In examples disclosed herein, when the query results 902 include code snippets, those code snippets include uncommented and/or non-self-documented code. If the database 106 does not return any matches, the database driver 208 transmits a “no match” message to the API 202 as the query results 902. Subsequently, the API 202 presents the “no match” message to the user.

In the illustrated example of FIG. 9, when a user sends a code snippet query, the code classifier 206 detects the intent of the code snippet query. For example, the code preprocessor 218 converts code snippets into text and separates the text of code snippet queries words, phrases, and/or other units. Additionally or alternatively, the code feature extractor 220 implements an AST to extracts and/or otherwise generate feature vectors including one or more of tokens of the words, phrases, and/or other units; PoC features; and/or types of the tokens (e.g., as determined by the AST). The CC model executor 222 determines the intent of the code snippet, regardless of whether the code snippet includes comments and/or whether the code snippet is self-documented. The CC model executor 222 forwards the intent to the database driver 208 to query the database 106. An example code snippet that the code classifier 206 processes is illustrated in connection with Table 2.

TABLE 2

| Code Line | Code |
|---|---|
| 0 | “def BS(A,low,hiv): |
| 1 | mid = round((hi+low)/2.0) |
| 2 | if v == mid: |
| 3 | print (“Done”) |
| 4 | elif v < mid: |
| 5 | print (“Smaller item”) |
| 6 | hi = mid-1 |
| 7 | BS(A,low,hi,v) |
| 8 | else: |
| 9 | print (“Greater item”) |
| 10 | low = mid + 1 |
| 11 | BS(A,low,hi,v)”, ... } |

In the illustrated example of FIG. 9, the code classifier 206 identifies the intent of the code snippet shown in Table 2 as “To implement a recursive binary search function.” In the example of FIG. 9, the database driver 208 performs a parameterized semantic query (e.g., in the Cypher query language) and returns a set of comment parameters from the ontology that match the intent of the code snippet query and/or other parameters for a related commit. For example, the database driver 208 queries the database 106 with the intent as determined by the CC model executor 222. For example, the database driver 208 transmits a query to the database 106 including the certainty and/or uncertainty parameters with which the CC model executor 222 determined the intent is included in the query. The resulting set of comment parameters and/or other parameters for a related commit from the ontology that match the intent of the code snippet describe the functionality of the code snippet included in the code snippet query. The database driver 208 determines whether the database 106 returned any matches with a threshold level of uncertainty. For example, the database 106 returns entries that are below the threshold level of uncertainty and include a matching intent. If the database 106 returns comment and/or other parameters for the code snippet query, the database driver 208 orders the results according to the certainty and/or the uncertainty parameters included therewith. Subsequently, the database driver 208 returns the query results 902 including a set of VCS commits matching the semantic query parameters to the API 202 to be presented to the requesting user. For example, the set of VCS commits includes comment parameters, message parameters, and/or intent parameters that allow a developer to quickly understand the code snippet included in the query. If the database 106 does not return any matches, the database driver 208 transmits a “no match” message to the API 202 as the query results 902. Subsequently, the API 202 presents the “no match” message to a requesting user.

While an example manner of implementing the semantic search engine 102 of FIG. 1 is illustrated in FIG. 2, one or more of the elements, processes and/or devices illustrated in FIG. 2 may be combined, divided, re-arranged, omitted, eliminated and/or implemented in any other way. Further, the example application programming interface (API) 202, the example natural language (NL) processor 204, the example code classifier 206, the example database driver 208, the example model trainer 210, the example natural language (NL) preprocessor 212, the example natural language (NL) feature extractor 214, the example natural language processing (NLP) model executor 216, the example code preprocessor 218, the example code feature extractor 220, the example code classification (CC) model executor 222, and/or, more generally, the example semantic search engine 102 of FIGS. 1 and/or 2 may be implemented by hardware, software, firmware and/or any combination of hardware, software and/or firmware. Thus, for example, any of the example application programming interface (API) 202, the example natural language (NL) processor 204, the example code classifier 206, the example database driver 208, the example model trainer 210, the example natural language (NL) preprocessor 212, the example natural language (NL) feature extractor 214, the example natural language processing (NLP) model executor 216, the example code preprocessor 218, the example code feature extractor 220, the example code classification (CC) model executor 222, and/or, more generally, the example semantic search engine 102 of FIGS. 1 and/or 2 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example application programming interface (API) 202, the example natural language (NL) processor 204, the example code classifier 206, the example database driver 208, the example model trainer 210, the example natural language (NL) preprocessor 212, the example natural language (NL) feature extractor 214, the example natural language processing (NLP) model executor 216, the example code preprocessor 218, the example code feature extractor 220, the example code classification (CC) model executor 222, and/or, more generally, the example semantic search engine 102 of FIGS. 1 and/or 2 is/are hereby expressly defined to include a non-transitory computer readable storage device or storage disk such as a memory, a digital versatile disk (DVD), a compact disk (CD), a Blu-ray disk, etc. including the software and/or firmware. Further still, the example semantic search engine 102 of FIGS. 1 and/or 2 may include one or more elements, processes and/or devices in addition to, or instead of, those illustrated in FIG. 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

Flowcharts representative of example hardware logic, machine readable instructions, hardware implemented state machines, and/or any combination thereof for implementing the semantic search engine 102 of FIGS. 1, 2, 5, and/or 9 are shown in FIGS. 10 and 11. The machine readable instructions may be one or more executable programs or portion(s) of an executable program for execution by a computer processor and/or processor circuitry, such as the processor 1212 shown in the example processor platform 1200 discussed below in connection with FIG. 12. The program may be embodied in software stored on a non-transitory computer readable storage medium such as a CD-ROM, a floppy disk, a hard drive, a DVD, a Blu-ray disk, or a memory associated with the processor 1212, but the entire program and/or parts thereof could alternatively be executed by a device other than the processor 1212 and/or embodied in firmware or dedicated hardware. In some examples disclosed herein, a non-transitory computer readable storage medium is referred to as a non-transitory computer-readable medium. Further, although the example program(s) is(are) described with reference to the flowcharts illustrated in FIGS. 10 and 11, many other methods of implementing the example semantic search engine 102 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine-readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 10 and/or 11 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 10 is a flowchart representative of machine-readable instructions 1000 which may be executed to implement the semantic search engine 102 of FIGS. 1, 2, and/or 5 to train the NLP model of FIGS. 2, 3, and/or 5, generate ontology metadata, and train the CC model of FIGS. 2, 3, and/or 5. The machine-readable instructions 1000 begin at block 1002 where the model trainer 210 trains an NLP model to classify the intent of NL queries, comment parameters, and/or message parameters. For example, at block 1002, the model trainer 210 causes the NLP model executor 216 to execute the NLP model on training data (e.g., the training data 400).

In the illustrated example of FIG. 10, at block 1004, the model trainer 210 determines whether the NLP model meets one or more error metrics. For example, the model trainer 210 determines whether the NLP model can correctly identify the intent of an NL string with a certainty parameter greater than 97% and an uncertainty parameter less than 15%. In response to the model trainer 210 determining that the NLP model meets the one or more error metrics (block 1004: YES), the machine-readable instructions 1000 proceed to block 1006. In response to the model trainer 210 determining that the NLP model does not meet the one or more error metrics (block 1004: NO), the machine-readable instructions 1000 return to block 1002.

In the illustrated example of FIG. 10, at block 1006, the model trainer 210 deploys the NLP model for execution in an inference phase. At block 1008, the API 202 accesses the VCS 108. At block 1010, the API 202 extracts metadata from the VCS 108 for a commit. For example, the metadata includes a change parameter, a subject parameter, a message parameter, a revision parameter, a file parameter, a code line parameter, a comment parameter, and/or a diff parameter. At block 1012, the API 202 generates a metadata structure including the metadata extracted from the VCS 108 for the commit. For example, the metadata structure may be an ontological representation such as that illustrated and described in connection with FIG. 6.

In the illustrated example of FIG. 10, at block 1014, the NL preprocessor 212, and/or, more generally, the NL processor 204, determines whether the commit includes a comment and/or message parameter. In response to the NL preprocessor 212 determining that the commit includes a comment and/or message parameter (block 1014: YES), the machine-readable instructions 1000 proceed to block 1016. In response to the NL preprocessor 212 determining that the commit does not include a comment and does not include a message parameter (block 1014: NO), the machine-readable instructions 1000 proceed to block 1024. At block 1016, the NL processor 204 preprocesses the comment and/or message parameters of the commit. For example, at block 1016, the NL preprocessor 212 preprocesses the comment and/or message parameters of the commit by separating the text of the comment and/or message parameters into words, phrases, and/or other units.

In the illustrated example of FIG. 10, at block 1018, the NL processor 204 generates NL features from the preprocessed comment and/or message parameters. For example, at block 1018, the NL feature extractor 214 extracts and/or otherwise generates features from the preprocessed comment and/or message parameters by generating tokens for keywords and/or entities of the preprocessed comment and/or message parameters. Additionally or alternatively, at block 1018, the NL feature extractor 214 generates PoS and Deps features from the preprocessed comment and/or message parameters.

In the illustrated example of FIG. 10, at block 1020, the NL processor 204 processes the NL features with the NLP model. For example, at block 1020, the NLP model executor 216 executes the NLP model with the NL features as an input to determine the intent of the comment and/or message parameters. At block 1022, the NL processor 204 supplements the metadata structure for the commit with the identified intent, keywords, and/or entities. For example, at block 1022, the NLP model executor 216 supplements the metadata structure for the commit with the identified intent, keywords, and/or entities. At block 1022, the NL processor 204 additionally supplements the metadata structure for the commit with the certainty and/or uncertainty parameters for the identified intent. For example, at block 1022, the NLP model executor 216 additionally supplements the metadata structure for the commit with the certainty and/or uncertainty parameters for the identified intent.

In the illustrated example of FIG. 10, at block 1024, the API 202 determines whether there are additional commits at the VCS 108. In response to the API 202 determining that there are additional commits (block 1024: YES), the machine-readable instructions 1000 return to block 1010. In response to the API 202 determining that there are not additional commits (block 1024: NO), the machine-readable instructions 1000 proceed to block 1026. At block 1026, the model trainer 210 trains the CC model using the supplemented metadata as described above.

In the illustrated example of FIG. 10, at block 1028, the model trainer 210 determines whether the CC model meets one or more error metrics. For example, the model trainer 210 determines whether the CC model can correctly identify the intent of a code snippet with a certainty parameter greater than 97% and an uncertainty parameter less than 15%. In response to the model trainer 210 determining that the CC model meets the one or more error metrics (block 1028: YES), the machine-readable instructions 1000 proceed to block 1030. In response to the model trainer 210 determining that the CC model does not meet the one or more error metrics (block 1028: NO), the machine-readable instructions 1000 return to block 1026. At block 1030, the model trainer 210 deploys the CC model for execution in an inference phase.

In the illustrated example of FIG. 10, at block 1032, the code classifier 206 preprocesses the code of the commit. For example, at block 1032, the code preprocessor 218 preprocesses the code of the commit by converting the code into text and separating the text into words, phrases, and/or other units. At block 1034, the code classifier 206 generates code snippet features from the preprocessed code. For example, at block 1034, the code feature extractor 220 extracts and/or otherwise generates features from the preprocessed code by generating tokens for the words, phrases, and/or other units. Additionally or alternatively, at block 1034, the code feature extractor 220 generates PoC features from the preprocessed code and/or token types for the tokens.

In the illustrated example of FIG. 10, at block 1036, the code classifier 206 processes the code snippet features with the CC model. For example, at block 1036, the CC model executor 222 executes the CC model with the code snippet features as an input to determine the intent of the code. At block 1038, the code classifier 206 supplements the metadata structure for the commit with the identified intent of the code. For example, at block 1038, the CC model executor 222 supplements the metadata structure for the commit with the identified intent. At block 1038, the code classifier 206 additionally supplements the metadata structure for the commit with the certainty and/or uncertainty parameters for the identified intent. For example, at block 1038, the CC model executor 222 additionally supplements the metadata structure for the commit with the certainty and/or uncertainty parameters for the identified intent.

In the illustrated example of FIG. 10, at block 1040, the code preprocessor 218, and/or, more generally, the code classifier 206, determines whether there are additional commits at the VCS 108 without comment parameters and without message parameters. In response to the code preprocessor 218 determining that there are additional commits at the VCS 108 without comment parameters and without message parameters (block 1040: YES), the machine-readable instructions 1000 return to block 1032. In response to the code preprocessor 218 determining that there are not additional commits at the VCS 108 without comment parameters and without message parameters (block 1040: NO), the machine-readable instructions 1000 terminate.

FIG. 11 is a flowchart representative of machine-readable instructions 1100 which may be executed to implements the semantic search engine 102 of FIGS. 1, 2, and/or 9 to process queries with the NLP model of FIGS. 2, 3, and/or 9 and/or the CC model of FIGS. 2, 3, and/or 9. The machine-readable instruction 1100 begin at block 1102 where the API 202 monitors for queries. At block 1104, the API 202 determines whether a query has been received. In response to the API 202 determining that a query has been received (block 1104: YES), the machine-readable instructions 1100 proceed to block 1106. In response to the API 202 determining that no query has been received (block 1104: NO), the machine-readable instructions 1100 return to block 1102.

In the illustrated example of FIG. 11, at block 1106, the API 202 determines whether the query includes a code snippet. In response to the API 202 determining that the query includes a code snippet (block 1106: YES), the machine-readable instructions 1100 proceed to block 1116. In response to the API 202 determining that the query does not include a code snippet (block 1106: NO), the machine-readable instructions 1100 proceed to block 1108. At block 1108, the NL processor 204 preprocesses the NL query. For example, at block 1108, the NL preprocessor 212 preprocesses the NL query by separating the text of the NL query into words, phrases, and/or other units. In examples disclosed herein, NL queries include text represented of a natural language query (e.g., a sentence).

In the illustrated example of FIG. 11, at block 1110, the NL processor 204 generates NL features from the preprocessed NL query. For example, at block 1110, the NL feature extractor 214 extracts and/or otherwise generates features from the preprocessed NL query by generating tokens for keywords and/or entities of the preprocessed NL query. Additionally or alternatively, at block 1110, the NL feature extractor 214 generates PoS and Deps features from the preprocessed NL query. In some examples, at block 1110, the NL feature extractor 214 merges the tokens, PoS features, and Deps features into a single input vector.

In the illustrated example of FIG. 11, at block 1112, the NL processor 204 processes the NL features with the NLP model. For example, at block 1112, the NLP model executor 216 executes the NLP model with the NL features as an input to determine the intent of the NL query. At block 1114, the NL processor 204 transmits the intent, keywords, and/or entities of the NL query to the database driver 208. For example, at block 1114, the NLP model executor 216 transmits the intent, keywords, and/or entities of the NL query to the database driver 208.

In the illustrated example of FIG. 11, at block 1116, the code classifier 206 preprocesses the code snippet query. For example, at block 1116, the code preprocessor 218 converts code snippets into text and separates the text of code snippet queries into words, phrases, and/or other entities. In examples disclosed herein, code snippet queries include macros, functions, structures, modules, and/or any other code that can be compiled and/or interpreted. For example, the code snippet queries may include JSON, XML, and/or other types of structures. At block 1118, the code classifier 206 extracts features from the preprocessed code snippet query. For example, at block 1118, the code feature extractor 220 extracts and/or otherwise generate feature vectors including one or more of tokens for the words, phrases, and/or other units; PoC features; and/or types of the tokens. In some examples, at block 1118, the code feature extractor 220 merges the tokens, PoC features, and types of tokens into a single input vector.

In the illustrated example of FIG. 11, at block 1120, the code classifier 206 processes the code snippet features with the CC model. For example, at block 1120, the CC model executor 222 executes the CC model on the code snippet features to determine the intent of the code snippet. In examples disclosed herein, the CC model executor 222 identifies the intent of a code snippet regardless of whether the code snippet includes comments and/or whether the code snippet is self-documented. At block 1122, the code classifier 206 transmits the intent of the code snippet to the database driver 208. For example, at block 1122, the CC model executor 222 transmits the intent of the code snippet to the database driver 208.

In the illustrated example of FIG. 11, at block 1124, the database driver 208 queries the database 106 with the output of the NL processor 204 and/or the code classifier 206. For example, at block 1124, the database driver 208 submits a parameterized semantic query (e.g., in the Cypher query language) to the database 106. At block 1126, the database driver 208 determines whether the database 106 returned matches to the query. In response to the database driver 208 determining that the database 106 returned matches to the query (block 1126: YES), the machine-readable instructions 1100 proceed to block 1130. In response to the database driver 208 determining that the database 106 did not return matches to the query (block 1126: NO), the database driver 208 transmits a “no match” message to the API 202 and the machine-readable instructions 1100 proceed to block 1128.

In the illustrated example of FIG. 11, at block 1128, the API 202 presents the “no match” message. If the database driver 208 returns a “no match” message for an NL query, the semantic search engine 102 monitors how the user develops a solution to the unknown NL query. After the user develops a solution to the NL query, the semantic search engine 102 stores the solution in the database 106 so that if the NL query that previously resulted in a “no match” message is resubmitted, the semantic search engine 102 returns the newly developed solution. Additionally or alternatively, if the database driver 208 returns a “no match” message for code snippet query, the semantic search engine 102 monitors how the user comments and/or otherwise reviews the unknown code snippet. After the user develops comments and/or other understand of the code snippet, the semantic search engine 102 stores comments and/or other understanding of the code snippet in the database 106 so that if the code snippet query that previously resulted in a “no match” message is resubmitted, the semantic search engine 102 returns the newly developed comments and/or understanding. In this manner, the semantic search engine 102 periodically updates the ontological representation of the VCS 108 as new commits are made.

In the illustrated example of FIG. 11, at block 1130, the database driver 208 orders the results of the query according to certainty and/or uncertainty parameters associated therewith. For example, for NL query results, the database driver 208 orders the result according the certainty and/or uncertainty with which the NLP model and/or the CC model identified the intent of code snippets that are returned. For example, for code snippet query results, the database driver 208 orders the result according the certainty and/or uncertainty with which the NLP model and/or the CC model identified the intent of comment parameters and/or other parameters of commits that are returned. After ordering the results at block 1130, the database driver 208 transmits the ordered results to the API 202.

In the illustrated example of FIG. 11, at block 1132, the API 202 presents the ordered results. At block 1134, the API 202 determines whether to continue operating. In response to the API 202 determining that the semantic search engine 102 is to continue operating (block 1134: YES), the machine-readable instructions 1100 return to block 1102. In response to the API 202 determining that the semantic search engine 102 is not to continue operating (block 1134: NO), the machine-readable instructions 1100 terminate. For example, conditions that cause the API 202 to determine that the semantic search engine 102 is not to continue operation include a user exiting out of an interface hosted by the API 202 and/or a user accessing an address other than that of a webpage hosted by the API 202.

FIG. 12 is a block diagram of an example processor platform 1200 structured to execute the instructions of FIGS. 10 and/or 11 to implement the semantic search engine 102 of FIGS. 1, 2, 5, and/or 9. The processor platform 1200 can be, for example, a server, a personal computer, a workstation, a self-learning machine (e.g., a neural network), a mobile device (e.g., a cell phone, a smart phone, a tablet such as an iPad), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 1200 of the illustrated example includes a processor 1212. The processor 1212 of the illustrated example is hardware. For example, the processor 1212 can be implemented by one or more integrated circuits, logic circuits, microprocessors, GPUs, DSPs, or controllers from any desired family or manufacturer. The hardware processor 1212 may be a semiconductor based (e.g., silicon based) device. In this example, the processor 1212 implements the example application programming interface (API) 202, the example natural language (NL) processor 204, the example code classifier 206, the example database driver 208, the example model trainer 210, the example natural language (NL) preprocessor 212, the example natural language (NL) feature extractor 214, the example natural language processing (NLP) model executor 216, the example code preprocessor 218, the example code feature extractor 220, the example code classification (CC) model executor 222.

The processor 1212 of the illustrated example includes a local memory 1213 (e.g., a cache). The processor 1212 of the illustrated example is in communication with a main memory including a volatile memory 1214 and a non-volatile memory 1216 via a bus 1218. The volatile memory 1214 may be implemented by Synchronous Dynamic Random-Access Memory (SDRAM), Dynamic Random-Access Memory (DRAM), RAMBUS® Dynamic Random-Access Memory (RDRAM®) and/or any other type of random-access memory device. The non-volatile memory 1216 may be implemented by flash memory and/or any other desired type of memory device. Access to the main memory 1214, 1216 is controlled by a memory controller.

The processor platform 1200 of the illustrated example also includes an interface circuit 1220. The interface circuit 1220 may be implemented by any type of interface standard, such as an Ethernet interface, a universal serial bus (USB), a Bluetooth® interface, a near field communication (NFC) interface, and/or a PCI express interface.

In the illustrated example, one or more input devices 1222 are connected to the interface circuit 1220. The input device(s) 1222 permit(s) a user to enter data and/or commands into the processor 1212. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1224 are also connected to the interface circuit 1220 of the illustrated example. The output devices 1224 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1220 of the illustrated example, thus, typically includes a graphics driver card, a graphics driver chip and/or a graphics driver processor.

The interface circuit 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1226. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1200 of the illustrated example also includes one or more mass storage devices 1228 for storing software and/or data. Examples of such mass storage devices 1228 include floppy disk drives, hard drive disks, compact disk drives, Blu-ray disk drives, redundant array of independent disks (RAID) systems, and digital versatile disk (DVD) drives.

The machine executable instructions 1232 of FIG. 12 implements the machine-readable instructions 1000 of FIG. 10 and/or the machine-readable instructions 1100 of FIG. 11 may be stored in the mass storage device 1228, in the volatile memory 1214, in the non-volatile memory 1216, and/or on a removable non-transitory computer readable storage medium such as a CD or DVD.

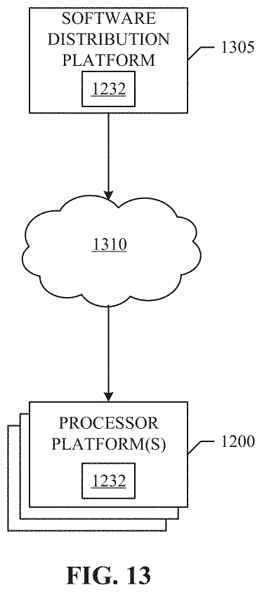

A block diagram illustrating an example software distribution platform 1305 to distribute software such as the example computer readable instructions 1232 of FIG. 12 to devices owned and/or operated by third parties is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 1232 of FIG. 12. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the computer readable instructions 1232, which may correspond to the example computer readable instructions 1000 of FIG. 10 and/or the computer readable instructions 1100 of FIG. 11, as described above. The one or more servers of the example software distribution platform 1305 are in communication with a network 1310, which may correspond to any one or more of the Internet and/or any of the example network 104 described above. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 1232 from the software distribution platform 1305. For example, the software, which may correspond to the example computer readable instructions 1232 of FIG. 12, may be downloaded to the example processor platform 1300, which is to execute the computer readable instructions 1232 to implement the semantic search engine 102. In some example, one or more servers of the software distribution platform 1305 periodically offer, transmit, and/or force updates to the software (e.g., the example computer readable instructions 1232 of FIG. 12) to ensure improvements, patches, updates, etc. are distributed and applied to the software at the end user devices.

From the foregoing, it will be appreciated that example methods, apparatus, and articles of manufacture have been disclosed that to identify and interpret code. Examples disclosed herein model version controlling system content (e.g., source code). The disclosed methods, apparatus and articles of manufacture improve the efficiency of using a computing device by reducing the time a developer uses a computer to develop a program and/or other code. The methods, apparatus, and articles of manufacture disclosed herein improve the reusability of code regardless of whether the code includes comments and/or whether the code is self-documented. The disclosed methods, apparatus and articles of manufacture are accordingly directed to one or more improvement(s) in the functioning of a computer.

Examples disclosed herein generate an ontological representation of a VCS, determine one or more intents of code within the VCS based on NLP of comment and/or message parameters within the ontological representation, train, with the determined one or more intents of the code within the VCS, a code classifier to determine the intent of uncommented and non-self-documented code, identify code that matches the intent of an NL query, and interpret uncommented and non-self-documented code to determine the comment, message, and/or intent parameters that accurately describe the code.

The NLP and code classification disclosed herein is performed with one or more BNNs that employ probabilistic distributions to determine certainty and/or uncertainty parameters for a given identified intent. As such, examples disclosed herein allow developers to reuse source code in a quicker and more effective manner that prevents redistilling solutions to problems when those solutions are already available through accessible repositories. For example, examples disclosed herein propose code snippets by estimating the intent of source code in accessibly repositories. Thus, examples disclosed herein improve (e.g., faster and/or more effective) the time to market for companies when developing products (e.g., software and/or hardware) and updates thereto. Accordingly, examples disclosed herein allow developers to spend more time working on new issues and more complicated and complex problems associated with developing a hardware and/or software product. Additionally, examples disclosed herein suggest code that has already been reviewed. Thus, examples disclosed herein allow developers to quickly implement code that is more efficient than independently generated, unreviewed, code.

Example methods, apparatus, systems, and articles of manufacture to identify and interpret code are disclosed herein. Further examples and combinations thereof include the following:

Example 1 includes an apparatus to identify and interpret code, the apparatus comprising a natural language (NL) processor to process NL features to identify a keyword, an entity, and an intent of an NL string included in an input retrieved from a user, a database driver to transmit a query to a database including an ontological representation of a version control system, wherein the query is a parameterized semantic query including the keyword, the entity, and the intent of the NL string, and an application programming interface (API) to present to the user a code snippet determined based on the query, the code snippet being at least one of uncommented or non-self-documented.

Example 2 includes the apparatus of example 1, wherein the input is a first input, the query is a first query, the parameterized semantic query is a first parameterized semantic query, and the code snippet is a first code snippet, the apparatus further includes a code classifier to process code snippet features to identify an intent of a second code snippet included in a second input retrieved from the user, the second code snippet being at least one of uncommented or non-self-documented, the database driver is to transmit a second query to the database, the second query being a second parameterized semantic query including the intent of the second code snippet, and the API is to present to the user a comment determined based on the second query, the comment describing the functionality of the second code snippet.

Example 3 includes the apparatus of example 2, wherein the API is to present the first code snippet and a third code snippet to the user, the first code snippet and the third code snippet ordered according to at least one of respective certainty or uncertainty parameters with which at least one of the NL processor or the code classifier determined when analyzing the first code snippet and the third code snippet, the third code snippet determined based on the first query.

Example 4 includes the apparatus of example 2, wherein the code classifier is to merge a first vector including tokens of the code snippet and a second vector representative of parts of code to which the tokens correspond into a third vector that is to be processed by the code classifier.

Example 5 includes the apparatus of example 1, wherein the ontological representation includes a graphical representation of data associated with one or more commits of the version control system, the data associated with the one or more commits including at least one of a change parameter, a subject parameter, a message parameter, a revision parameter, a file parameter, a code line parameter, a comment parameter, or a diff parameter.

Example 6 includes the apparatus of example 1, wherein the code snippet was previously developed.

Example 7 includes the apparatus of example 1, wherein the NL processor is to merge a first vector including tokens of the NL string, a second vector representative of parts of speech to which the tokens correspond, and a third vector representative of dependencies between the tokens into a fourth vector that is to be processed by the NL processor.

Example 8 includes a non-transitory computer-readable medium comprising instructions which, when executed, cause at least one processor to at least process natural language (NL) features to identify a keyword, an entity, and an intent of an NL string included in an input retrieved from a user, transmit a query to a database including an ontological representation of a version control system, wherein the query is a parameterized semantic query including the keyword, the entity, and the intent of the NL string, and present to the user a code snippet determined based on the query, the code snippet being at least one of uncommented or non-self-documented.

Example 9 includes the non-transitory computer-readable medium of example 8, wherein the input is a first input, the query is a first query, the parameterized semantic query is a first parameterized semantic query, the code snippet is a first code snippet, and the instructions, when executed, cause the at least one processor to process code snippet features to identify an intent of a second code snippet included in a second input retrieved from the user, the second code snippet being at least one of uncommented or non-self-documented, transmit a second query to the database, the second query being a second parameterized semantic query including the intent of the second code snippet, and present to the user a comment determined based on the second query, the comment describing the functionality of the second code snippet.

Example 10 includes the non-transitory computer-readable medium of example 9, wherein the instructions, when executed, cause the at least one processor to merge a first vector including tokens of the code snippet and a second vector representative of parts of code to which the tokens correspond into a third vector that is to be processed by at least one BNN.

Example 11 includes the non-transitory computer-readable medium of example 8, wherein the ontological representation includes a graphical representation of data associated with one or more commits of the version control system, the data associated with the one or more commits including at least one of a change parameter, a subject parameter, a message parameter, a revision parameter, a file parameter, a code line parameter, a comment parameter, or a diff parameter.

Example 12 includes the non-transitory computer-readable medium of example 8, wherein the code snippet was previously developed.

Example 13 includes the non-transitory computer-readable medium of example 8, wherein the instructions, when executed, cause the at least one processor to merge a first vector including tokens of the NL string, a second vector representative of parts of speech to which the tokens correspond, and a third vector representative of dependencies between the tokens into a fourth vector that is to be processed by at least one BNN.

Example 14 includes an apparatus to identify and interpret code, the apparatus comprising memory, and at least one processor to execute machine readable instructions to cause the at least one processor to process natural language (NL) features to identify a keyword, an entity, and an intent of an NL string included in an input retrieved from a user, transmit a query to a database including an ontological representation of a version control system, wherein the query is a parameterized semantic query including the keyword, the entity, and the intent of the NL string, and present to the user a code snippet determined based on the query, the code snippet being at least one of uncommented or non-self-documented.

Example 15 includes the apparatus of example 14, wherein the input is a first input, the query is a first query, the parameterized semantic query is a first parameterized semantic query, the code snippet is a first code snippet, and the at least one processor is to process code snippet features to identify an intent of a second code snippet included in a second input retrieved from the user, the second code snippet being at least one of uncommented or non-self-documented, transmit a second query to the database, the second query being a second parameterized semantic query including the intent of the second code snippet, and present to the user a comment determined based on the second query, the comment describing the functionality of the second code snippet.

Example 16 includes the apparatus of example 15, wherein the at least one processor is to merge a first vector including tokens of the code snippet and a second vector representative of parts of code to which the tokens correspond into a third vector that is to be processed by at least one BNN.

Example 17 includes the apparatus of example 14, wherein the ontological representation includes a graphical representation of data associated with one or more commits of the version control system, the data associated with the one or more commits including at least one of a change parameter, a subject parameter, a message parameter, a revision parameter, a file parameter, a code line parameter, a comment parameter, or a diff parameter.

Example 18 includes the apparatus of example 14, wherein the code snippet was previously developed.

Example 19 includes the apparatus of example 14, wherein the at least one processor is to merge a first vector including tokens of the NL string, a second vector representative of parts of speech to which the tokens correspond, and a third vector representative of dependencies between the tokens into a fourth vector that is to be processed by at least one BNN.

Example 20 includes a method to identify and interpret code, the method comprising processing natural language (NL) features to identify a keyword, an entity, and an intent of an NL string included in an input retrieved from a user, transmitting a query to a database including an ontological representation of a version control system, wherein the query is a parameterized semantic query including the keyword, the entity, and the intent of the NL string, and presenting to the user a code snippet determined based on the query, the code snippet being at least one of uncommented or non-self-documented.

Example 21 includes the method of example 20, wherein the input is a first input, the query is a first query, the parameterized semantic query is a first parameterized semantic query, the code snippet is a first code snippet, and the method further includes processing code snippet features to identify an intent of a second code snippet included in a second input retrieved from the user, the second code snippet being at least one of uncommented or non-self-documented, transmitting a second query to the database, the second query being a second parameterized semantic query including the intent of the second code snippet, and presenting to the user a comment determined based on the second query, the comment describing the functionality of the second code snippet.

Example 22 includes the method of example 21, further including merging a first vector including tokens of the code snippet and a second vector representative of parts of code to which the tokens correspond into a third vector that is to be processed by at least one BNN.

Example 23 includes the method of example 20, wherein the ontological representation includes a graphical representation of data associated with one or more commits of the version control system, the data associated with the one or more commits including at least one of a change parameter, a subject parameter, a message parameter, a revision parameter, a file parameter, a code line parameter, a comment parameter, or a diff parameter.

Example 24 includes the method of example 20, wherein the code snippet was previously developed.

Example 25 includes the method of example 20, further including merging a first vector including tokens of the NL string, a second vector representative of parts of speech to which the tokens correspond, and a third vector representative of dependencies between the tokens into a fourth vector that is to be processed by at least one BNN.

Example 26 includes an apparatus to identify and interpret code, the apparatus comprising means for processing natural language (NL) to process NL features to identify a keyword, an entity, and an intent of an NL string included in an input retrieved from a user, means for driving database access to transmit a query to a database including an ontological representation of a version control system, wherein the query is a parameterized semantic query including the keyword, the entity, and the intent of the NL string, and means for interfacing to present to the user a code snippet determined based on the query, the code snippet being at least one of uncommented or non-self-documented.

Example 27 includes the apparatus of example 26, wherein the input is a first input, the query is a first query, the parameterized semantic query is a first parameterized semantic query, and the code snippet is a first code snippet, the apparatus further includes means for classifying code to process code snippet features to identify an intent of a second code snippet included in a second input retrieved from the user, the second code snippet being at least one of uncommented or non-self-documented, the means for driving database access is to transmit a second query to the database, the second query being a second parameterized semantic query including the intent of the second code snippet, and the means for interfacing is to present to the user a comment determined based on the second query, the comment describing the functionality of the second code snippet.

Example 28 includes the apparatus of example 27, wherein the means for classifying code is to merge a first vector including tokens of the code snippet and a second vector representative of parts of code to which the tokens correspond into a third vector that is to be processed by the means for classifying code.

Example 29 includes the apparatus of example 26, wherein the ontological representation includes a graphical representation of data associated with one or more commits of the version control system, the data associated with the one or more commits including at least one of a change parameter, a subject parameter, a message parameter, a revision parameter, a file parameter, a code line parameter, a comment parameter, or a diff parameter.

Example 30 includes the apparatus of example 26, wherein the code snippet was previously developed.

Example 31 includes the apparatus of example 26, wherein the means for processing NL is to merge a first vector including tokens of the NL string, a second vector representative of parts of speech to which the tokens correspond, and a third vector representative of dependencies between the tokens into a fourth vector that is to be processed by the means for processing NL. Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

1. An apparatus to identify and interpret code, the apparatus comprising:
a natural language (NL) processor to process NL features to identify a keyword, an entity, and an intent of an NL string included in an input retrieved from a user;
a database driver to transmit a query to a database including an ontological representation of a version control system, wherein the query is a parameterized semantic query including the keyword, the entity, and the intent of the NL string; and
an application programming interface (API) to present to the user a code snippet determined based on the query, the code snippet being at least one of uncommented or non-self-documented.

2. The apparatus of claim 1, wherein:
the input is a first input, the query is a first query, the parameterized semantic query is a first parameterized semantic query, and the code snippet is a first code snippet;
the apparatus further includes a code classifier to process code snippet features to identify an intent of a second code snippet included in a second input retrieved from the user, the second code snippet being at least one of uncommented or non-self-documented;
the database driver is to transmit a second query to the database, the second query being a second parameterized semantic query including the intent of the second code snippet; and
the API is to present to the user a comment determined based on the second query, the comment describing the functionality of the second code snippet.

3. The apparatus of claim 2, wherein the API is to present the first code snippet and a third code snippet to the user, the first code snippet and the third code snippet ordered according to at least one of respective certainty or uncertainty parameters with which at least one of the NL processor or the code classifier determined when analyzing the first code snippet and the third code snippet, the third code snippet determined based on the first query.

4. The apparatus of claim 2, wherein the code classifier is to merge a first vector including tokens of the code snippet and a second vector representative of parts of code to which the tokens correspond into a third vector that is to be processed by the code classifier.

5. The apparatus of claim 1, wherein the ontological representation includes a graphical representation of data associated with one or more commits of the version control system, the data associated with the one or more commits including at least one of a change parameter, a subject parameter, a message parameter, a revision parameter, a file parameter, a code line parameter, a comment parameter, or a diff parameter.

6. The apparatus of claim 1, wherein the code snippet was previously developed.

7. The apparatus of claim 1, wherein the NL processor is to merge a first vector including tokens of the NL string, a second vector representative of parts of speech to which the tokens correspond, and a third vector representative of dependencies between the tokens into a fourth vector that is to be processed by the NL processor.

8. A non-transitory computer-readable medium comprising instructions which, when executed, cause at least one processor to at least:
process natural language (NL) features to identify a keyword, an entity, and an intent of an NL string included in an input retrieved from a user;
transmit a query to a database including an ontological representation of a version control system, wherein the query is a parameterized semantic query including the keyword, the entity, and the intent of the NL string; and
present to the user a code snippet determined based on the query, the code snippet being at least one of uncommented or non-self-documented.

9. The non-transitory computer-readable medium of claim 8, wherein the input is a first input, the query is a first query, the parameterized semantic query is a first parameterized semantic query, the code snippet is a first code snippet, and the instructions, when executed, cause the at least one processor to:
process code snippet features to identify an intent of a second code snippet included in a second input retrieved from the user, the second code snippet being at least one of uncommented or non-self-documented;
transmit a second query to the database, the second query being a second parameterized semantic query including the intent of the second code snippet; and
present to the user a comment determined based on the second query, the comment describing the functionality of the second code snippet.

10. The non-transitory computer-readable medium of claim 9, wherein the instructions, when executed, cause the at least one processor to merge a first vector including tokens of the code snippet and a second vector representative of parts of code to which the tokens correspond into a third vector that is to be processed by at least one BNN.

11. The non-transitory computer-readable medium of claim 8, wherein the ontological representation includes a graphical representation of data associated with one or more commits of the version control system, the data associated with the one or more commits including at least one of a change parameter, a subject parameter, a message parameter, a revision parameter, a file parameter, a code line parameter, a comment parameter, or a diff parameter.

12. The non-transitory computer-readable medium of claim 8, wherein the code snippet was previously developed.

13. The non-transitory computer-readable medium of claim 8, wherein the instructions, when executed, cause the at least one processor to merge a first vector including tokens of the NL string, a second vector representative of parts of speech to which the tokens correspond, and a third vector representative of dependencies between the tokens into a fourth vector that is to be processed by at least one BNN.

14. An apparatus to identify and interpret code, the apparatus comprising:
memory; and
at least one processor to execute machine readable instructions to cause the at least one processor to:
process natural language (NL) features to identify a keyword, an entity, and an intent of an NL string included in an input retrieved from a user;
transmit a query to a database including an ontological representation of a version control system, wherein the query is a parameterized semantic query including the keyword, the entity, and the intent of the NL string; and
present to the user a code snippet determined based on the query, the code snippet being at least one of uncommented or non-self-documented.

15. The apparatus of claim 14, wherein the input is a first input, the query is a first query, the parameterized semantic query is a first parameterized semantic query, the code snippet is a first code snippet, and the at least one processor is to:
process code snippet features to identify an intent of a second code snippet included in a second input retrieved from the user, the second code snippet being at least one of uncommented or non-self-documented;
transmit a second query to the database, the second query being a second parameterized semantic query including the intent of the second code snippet; and
present to the user a comment determined based on the second query, the comment describing the functionality of the second code snippet.

16. The apparatus of claim 15, wherein the at least one processor is to merge a first vector including tokens of the code snippet and a second vector representative of parts of code to which the tokens correspond into a third vector that is to be processed by at least one BNN.

17. The apparatus of claim 14, wherein the ontological representation includes a graphical representation of data associated with one or more commits of the version control system, the data associated with the one or more commits including at least one of a change parameter, a subject parameter, a message parameter, a revision parameter, a file parameter, a code line parameter, a comment parameter, or a diff parameter.

18. The apparatus of claim 14, wherein the code snippet was previously developed.

19. The apparatus of claim 14, wherein the at least one processor is to merge a first vector including tokens of the NL string, a second vector representative of parts of speech to which the tokens correspond, and a third vector representative of dependencies between the tokens into a fourth vector that is to be processed by at least one BNN.

20. A method to identify and interpret code, the method comprising:
processing natural language (NL) features to identify a keyword, an entity, and an intent of an NL string included in an input retrieved from a user;
transmitting a query to a database including an ontological representation of a version control system, wherein the query is a parameterized semantic query including the keyword, the entity, and the intent of the NL string; and
presenting to the user a code snippet determined based on the query, the code snippet being at least one of uncommented or non-self-documented.

21. The method of claim 20, wherein the input is a first input, the query is a first query, the parameterized semantic query is a first parameterized semantic query, the code snippet is a first code snippet, and the method further includes:
processing code snippet features to identify an intent of a second code snippet included in a second input retrieved from the user, the second code snippet being at least one of uncommented or non-self-documented;
transmitting a second query to the database, the second query being a second parameterized semantic query including the intent of the second code snippet; and
presenting to the user a comment determined based on the second query, the comment describing the functionality of the second code snippet.

22. The method of claim 21, further including merging a first vector including tokens of the code snippet and a second vector representative of parts of code to which the tokens correspond into a third vector that is to be processed by at least one BNN.

23. The method of claim 20, wherein the ontological representation includes a graphical representation of data associated with one or more commits of the version control system, the data associated with the one or more commits including at least one of a change parameter, a subject parameter, a message parameter, a revision parameter, a file parameter, a code line parameter, a comment parameter, or a diff parameter.

24. The method of claim 20, wherein the code snippet was previously developed.

25. The method of claim 20, further including merging a first vector including tokens of the NL string, a second vector representative of parts of speech to which the tokens correspond, and a third vector representative of dependencies between the tokens into a fourth vector that is to be processed by at least one BNN.

26.-31. (canceled)
